(19) United States
(12) Patent Application Publication
(10) Pub. No.: US 2006/0201293 A1
(43) Pub. Date: Sep. 14, 2006

(54) Lighting apparatus

(76) Inventor: Brian N. Tufte, Eden Prairie, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/079,432

(22) Filed: Mar. 14, 2005

(51) Int. Cl. B26D 3/00

(52) U.S. Cl. 83/13

(57) ABSTRACT

A lighting apparatus is disclosed for illuminating an object or equipment including, for example, vehicles (such as cars recreational vehicles, boats, etc.), retail and/or store shelving and/or equipment, bars, desks, counters, walls, railings, steps, and/or any other object or surface, as desired. In some embodiments, the lighting apparatus includes a bumper. When so provided, the lighting apparatus may help provide a level of protection to objects and/or surfaces that are subject to bumping, sliding or other abuse.

### BACKGROUND

This invention relates to lights, and more particularly, to lights for illuminating, protecting and/or increasing the visual appeal of an object or surface.

### SUMMARY

The present invention provides a lighting apparatus that may be used to illuminate an object or surface. In one illustrative embodiment, the lighting apparatus is used to help improve the visibility of a vehicle by illuminating along one or more side surfaces of the vehicle. It is believed that by providing such visibility, vehicle safety can be significantly improved. In other illustrative embodiments, the lighting apparatus may be used to illuminate other objects or equipment including, for example, retail and/or store shelving and/or equipment, bars, desks, counters, walls, railings, steps, and/or any other object or surface, as desired. In some embodiments, the lighting apparatus includes a bumper. When so provided, the lighting apparatus may help provide a level of protection to objects and/or surfaces that are subject to bumping, sliding or other abuse. In other illustrative embodiments, the lighting apparatus may be used to increase the visual appeal of an object or surface.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a perspective view of a boat having a first illustrative boat lighting apparatus;

FIG. 2 is a perspective view of a boat having another illustrative boat lighting apparatus;

FIG. 3 is a schematic view of a boat hull having a number of boat lights, each directing light rays in a downward direction;

FIG. 4 is a schematic view of a boat hull having a number of boat lights, each directing light rays in an upward direction;

FIG. 5 is a schematic view of a boat hull having a number of boat lights, each directing light rays in forward and backward direction;

FIG. 6 is a partial cross-sectional perspective view of a boat hull having an illustrative elongated lighting apparatus;

FIG. 7 is a partial cross-sectional side view of a boat hull having another illustrative boat lighting apparatus;

FIG. 8 is a partial cross-sectional side view of a boat hull having a boat lighting apparatus incorporated into a side bumper assembly;

FIG. 9 is a partial cross-sectional side view of a boat hull having a boat lighting apparatus incorporated into an outward extending hull portion;

FIG. 10 is a perspective view of a personal watercraft having a boat lighting apparatus mounted thereto;

FIG. 11 is a cross-sectional side view of an illustrative lighting apparatus that includes a bumper member;

FIG. 12 is a cross-sectional side view of an illustrative lighting apparatus that includes a bumper member, wherein at least a portion of the bumper member is adapted to transmit light;

FIG. 13 is a cross-sectional side view of another illustrative lighting apparatus that includes a bumper member, wherein the bumper member is adapted to receive a light source and transmit light;

FIG. 14 is a cross-sectional side view of an illustrative lighting apparatus that includes a carrier and a bumper member, wherein the carrier is adapted to receive a light source;

FIG. 15 is a cross-sectional side view of another illustrative lighting apparatus that includes a carrier that is adapted to receive a light source;

FIG. 16 is a cross-sectional side view of yet another illustrative lighting apparatus that includes a carrier that is adapted to receive a light source;

FIG. 17 is a cross-sectional side view of an illustrative Fresnel lens that may be used in accordance various embodiments of the present invention;

FIG. 18 is a cross-sectional side view of another illustrative lighting apparatus that includes a carrier that is adapted to receive a light source;

FIG. 19 is a cross-sectional side view of another illustrative lighting apparatus that includes a carrier that is adapted to receive a light source;

FIG. 20 is a cross-sectional side view of another illustrative lighting apparatus that includes a carrier, wherein the carrier includes a parabolic shaped recess for receiving a light source;

FIG. 21 is a cross-sectional side view of another illustrative lighting apparatus that includes a carrier and a bumper member, wherein the carrier includes a recess for receiving a light source;

FIG. 22 is a cross-sectional side view of another illustrative lighting apparatus that includes a two piece carrier, wherein the first piece includes a recess for receiving a light source and the second piece provides a cover for the recess;

FIG. 23 is a cross-sectional side view of another illustrative lighting apparatus in accordance with the present invention;

FIG. 24 is a cross-sectional side view of yet another illustrative lighting apparatus in accordance with the present invention;

FIG. 25 is a schematic view of a truck with an illustrative lighting apparatus mounted to the side thereof;

FIG. 26 is a schematic view of an object that has an illustrative lighting apparatus mounted to the side thereof;

FIG. 27 is a cross-sectional side view of another illustrative lighting apparatus in accordance with the present invention;

FIG. 28A is a cross-sectional side view of the elongated bumper member (or insert) 700 of FIG. 27, with the slit 706 in the closed position;

FIG. 28B is a cross-sectional side view of the elongated bumper member (or insert) of FIG. 27, with the slit in an open position;

FIG. 28C is a cross-sectional side view of the insert of FIG. 27, with the slit in an open position and with a slit latching mechanism;

FIG. 29 is a cross-sectional side view of another illustrative lighting apparatus in accordance with the present invention;

FIG. 30 is a cross-sectional side view of an illustrative rub-rail with nubs in accordance with the present invention;

FIG. 31 is a cross-sectional side view of an illustrative lighting apparatus with nubs in accordance the present invention;

FIG. 32 is a cross-sectional side view of an illustrative lighting apparatus for receiving an elongated light source;

FIG. 33 is a cross-sectional side view of another illustrative lighting apparatus for receiving an elongated light source;

FIG. 34 is a cross-sectional side view of yet another illustrative lighting apparatus for receiving an elongated light source;

FIG. 35 is a cross-sectional side view of another illustrative lighting apparatus for receiving an elongated light source;

FIG. 36 is a cross-sectional side view of yet another illustrative lighting apparatus attached to a substrate;

FIG. 37 is a cross-sectional side view of an illustrative lighting apparatus for securing an elongated light source to a substrate;

FIG. 38 is a cross-sectional side view of an illustrative lighting apparatus for use with a stair or other ledge;

FIGS. 39A-39D are perspective views showing another illustrative lighting apparatus including features to assist a user with the removal of at least a length of the elongated light source through a side of the lighting apparatus;

FIG. 40 is a perspective view showing another illustrative light apparatus;

FIG. 41 is a cross-sectional side view of an illustrative lighting apparatus with a thinned wall portion adjacent at least one side of the elongated light source to assist a user with the removal of at least a length of the elongated light source through the thinned side portion of the lighting apparatus;

FIG. 42 is a cross-sectional side view of yet an illustrative lighting apparatus with a light source protecting member to help assist a user cut a side surface of the lighting apparatus to expose the elongated light source without damaging the elongated light source during the removal of at least a length of the elongated light source through a side of the lighting apparatus;

FIG. 43 is a cross-sectional side view of an illustrative lighting apparatus with a different material adjacent at least one side of the elongated light source to assist a user with the removal of at least a length of the elongated light source through the side of the lighting apparatus;

FIG. 44 is a cross-sectional side view of an illustrative lighting apparatus with a tear member positioned adjacent at least one side of the elongated light source to assist in tearing a wall of the lighting apparatus adjacent the elongated light source to assist a user with the removal of at least a length of the elongated light source through a wall of the lighting apparatus;

FIG. 45 is a partial perspective cut away view of an illustrative lighting apparatus that is bent around a corner and has a resulting stress profile across its width, with an elongated light source positioned at or near the minimum of the stress profile; and

FIG. 46 is a partial perspective cut away view of an illustrative lighting apparatus that is bent around a corner and has an elongated light source receiving cavity that is larger in the direction of the bend to help reduce the stress on the elongated light source.

### DETAILED DESCRIPTION

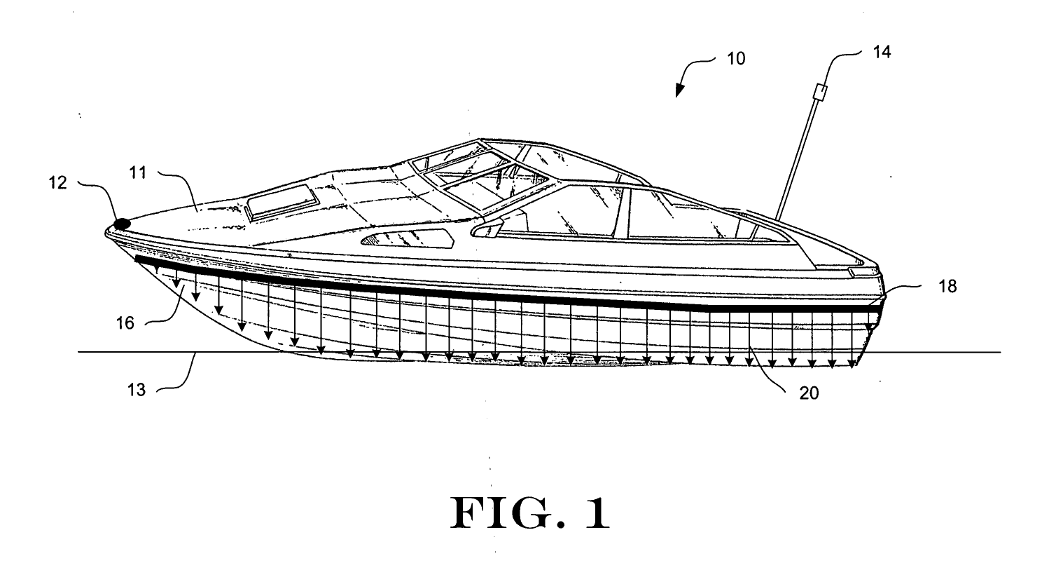

FIG. 1 is a perspective view of a boat 10 having a first illustrative boat lighting apparatus in accordance with the present invention. The boat is generally shown at 10, and includes an upper deck 11 extending over a hull 16. The hull 16 extends generally down from the upper deck 11 toward an expected water line 13. The hull 16 may also extend generally inward, as shown.

Prior art navigation lights typically include forward running lights 12 and a rear masthead light 14. The forward running lights 12 typically include a red port light and a green starboard light. In many cases, the forward running lights 12 are provided in a relatively small housing mounted to the front of the boat. The rear masthead light 14 is shown mounted higher than the forward running lights 12, and is visible from the front of the boat.

This lighting configuration may be adequate for experienced boaters traveling in relatively low traffic waterways under good weather conditions. However, under other conditions, they are less desirable. Many of today's waterways are extremely crowded, often occupied with high powered boats driven by inexperienced and inattentive boaters. Safely operating a boat at night under these conditions can be a challenge. Depth perception is limited, and lights along the shoreline can cast misleading reflections on the water. In many instances, simply identifying boats via the forward running lights 12 and the masthead light 14 can be difficult, let along determining the size, direction, speed, and other factors needed to safely travel the waterways.

To augment the basic running lights 12 and 14 shown in FIG. 1, the present invention contemplates providing a boat lighting apparatus that improves the visibility of a boat by illuminating one or more side surfaces of the hull 16 of the boat 10. The hull 16 of the boat provides a relatively large area that, when illuminated, can significantly increase the visibility of a boat 10. In addition, the size, direction, and speed of a boat 10 can more readily be determined, even by novice or inattentive boaters. It is believed that by providing such visibility, boat safety can be significantly improved.

In the illustrative embodiment shown in FIG. 1, a boat lighting apparatus 18 is provided along the length of the hull 16 of the boat 10. The boat lighting apparatus 18 includes one or more light sources for producing light rays 20. The boat lighting apparatus 18 may be mounted to the boat and configured such that at least a portion of the light rays 20 illuminate a portion of the hull 16. In the embodiment shown, the boat lighting apparatus 18 provides light rays 20 that illuminate a substantial portion of the outer surface of the hull 16. Although not shown, the boat lighting apparatus 18 may continue around the perimeter of the boat hull 16, and illuminate both side surfaces of the hull and the back surface of the hull. The boat lighting apparatus 18 may provide a different color light for each side of the boat, such as a red light on the port side, a green light on the starboard side and a while light on the back side.

It is contemplated that the boat lighting apparatus 18 may or may not include a redirector (see below) for redirecting at least a portion of the light rays 20 to the side surface of the hull 16. The redirector may also prevent at least a portion of the light rays from traveling horizontally away and/or upward from the hull 16 of the boat 10.

A method of the present invention includes the steps of providing one or more light sources, and mounting the one or more light sources to the boat such that when energized, the one or more light sources illuminate a side surface of the hull 16.

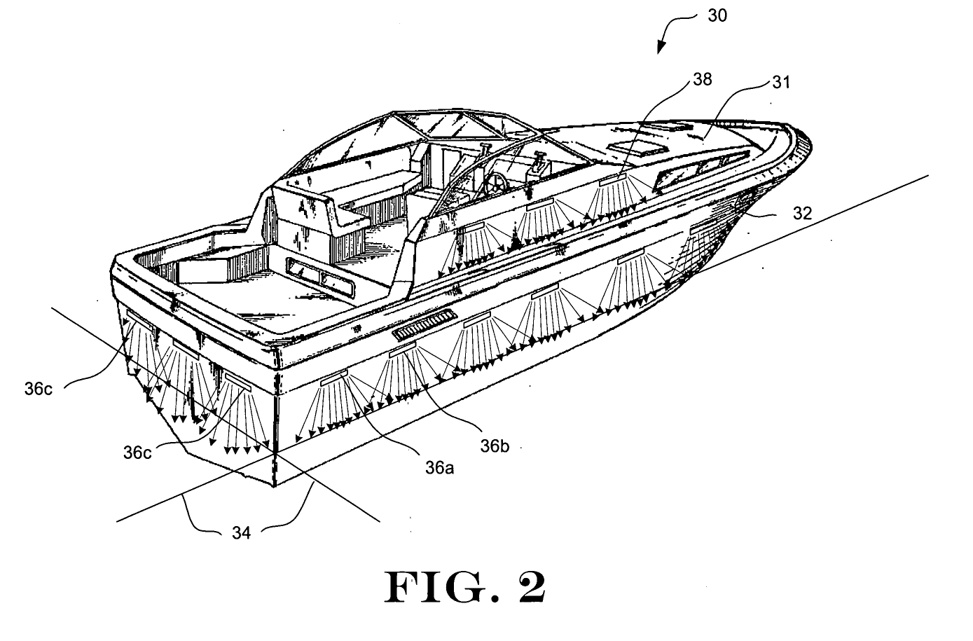

FIG. 2 is a perspective view of a boat having another illustrative boat lighting apparatus. The boat is generally shown at 30, and includes an upper deck 31 extending over a hull 32. The hull 32 extends generally down from the upper deck 31 toward an expected water line 34. The hull 32 may also extends generally inward, as shown. In this embodiment, a number of boat lights 36a, 36b, 36c and 36d are mounted to the hull 32 of the boat 30. Boat lights 36a and 36b are mounted to the starboard side of the hull 32, and boat lights 36c and 36d are mounted to the back of the hull 32.

In the illustrative embodiment, each of the boat lights 36a, 36b, 36c and 36d includes at least one light source for producing a number of light rays and an elongated carrier for carrying the at least one light sources. The elongated carrier is preferably adapted for directing the light rays down to the boat hull 32 along a longitudinally extending axis, wherein the longitudinally extending axis has a length that is substantially longer than the width of the carrier, as shown.

It is also contemplated that when the upper deck 31 includes one or more relatively vertically extending surfaces, additional boat lights 38 may be provided to illuminate these side surfaces as well. This may even further increase the visibility of the boat 30.

FIG. 3 is a schematic view of a boat hull having a number of boat lights, each directing light rays in a downward direction. While rectangular shaped boat lights are shown, it is contemplated that the boat lights may assume any desired shape. A hull is illustrated at 40 with a number of boat lights 40a, 40b, 40c and 40d mounted thereto. Boat lights 40a and 40b are shown mounted near the top of hull 40 and provide light rays in a generally downward direction. Boat lights 40c and 40d are shown mounted in an intermediate location on hull 40, and also provide light rays in a generally downward direction.

It is recognized that only the upper row of boat lights 40a and 40b may be necessary to illuminate the boat hull 40 down to the expected water line. Some hull designs may curve significantly inward toward the expected water line. For these boat hulls, it has been found that water at the water line of the boat may reflect some of the light provided by the upper row of boat lights 40a and 40b toward the hull of the boat. In some embodiments, one or more lower rows of boat lights, such as boat lights 40c and 40d, may be provided to help illuminate the lower portion of the boat hull 40, if desired.

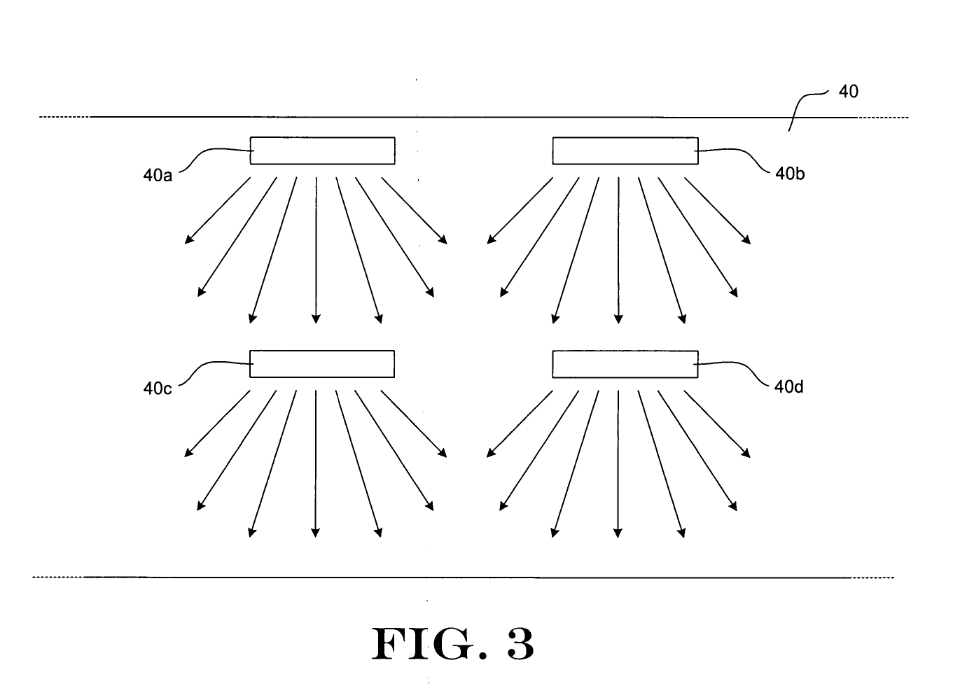

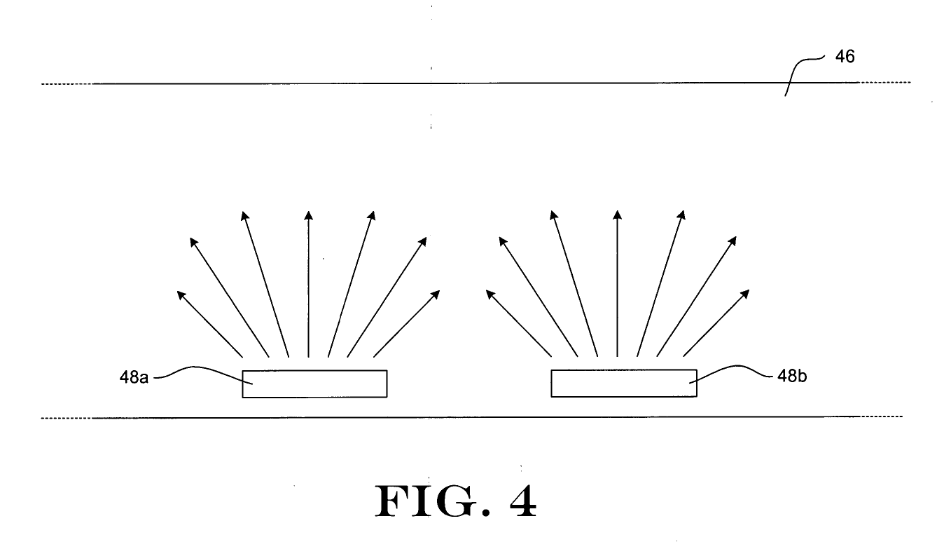

FIG. 4 is a schematic view of a boat hull having a number of boat lights, each directing light rays in an upward direction. A hull is illustrated at 46 with a number of boat lights 48a and 48b mounted thereto. Boat lights 48a and 48b are shown mounted on a lower portion of hull 46, and provide light rays in a generally upward direction.

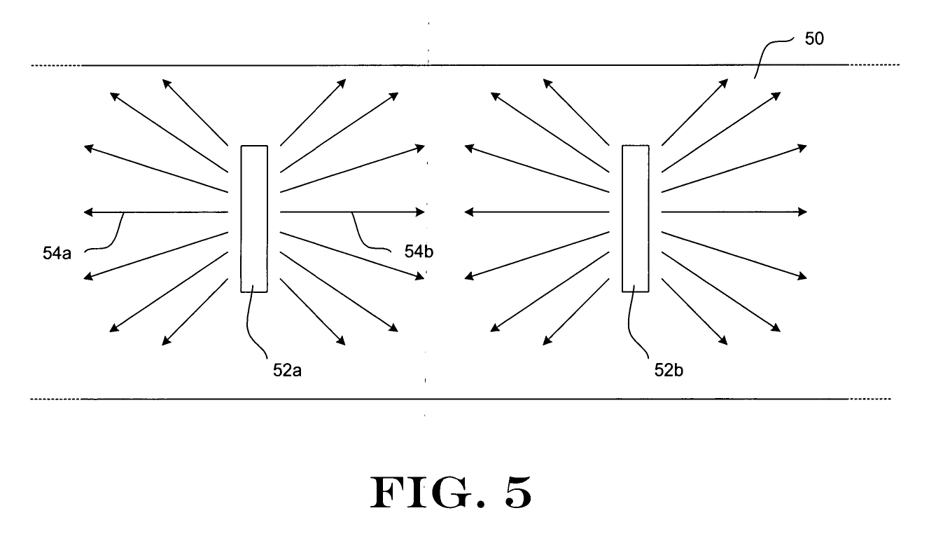

FIG. 5 is a schematic view of a boat hull having a number of boat lights, each directing light rays in forward and backward direction. A hull is illustrated at 50 with a number of boat lights 52a and 52b mounted thereto. Boat lights 52a and 52b are shown mounted on the hull 50, and may provide light rays in a forward direction, a backward direction, or both. For example, boat light 52a may provide light rays 54a in a generally backward direction, light rays 54b in a generally forward direction, or both.

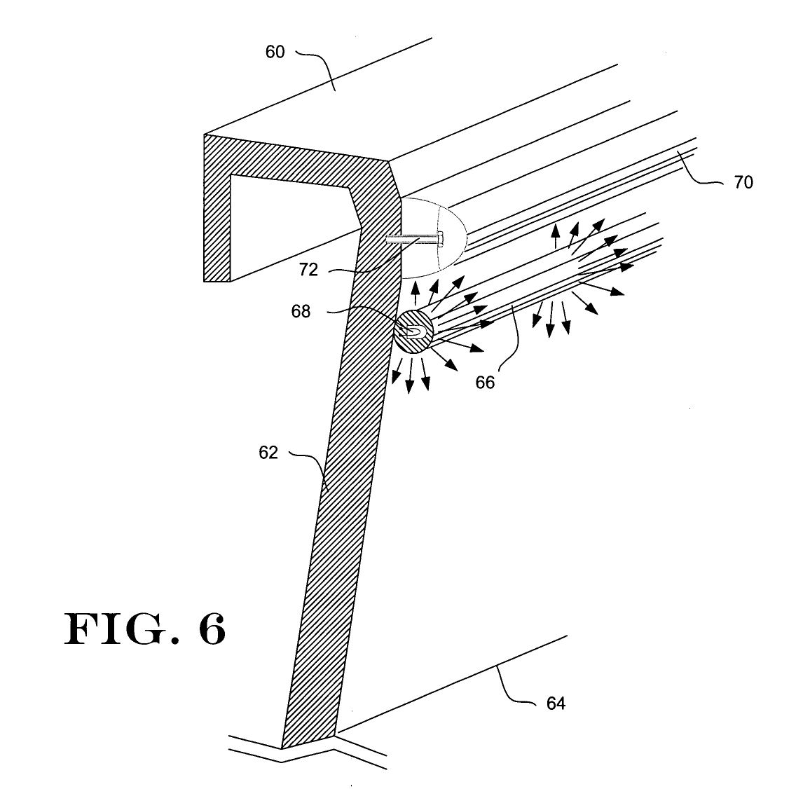

FIG. 6 is a partial cross-sectional perspective view of a boat hull 60 having an illustrative elongated boat lighting apparatus 66. The boat hull 60 includes a generally downward extending portion 62 that extends to an expected water line 64. The boat hull 60 may also include a bumper assembly 70 for protecting the boat hull 60 from docks or the like. The bumper assembly 70 is shown mounted on a top portion of the downward extending portion 62 of the boat hull 60 via mounting bolt 72.

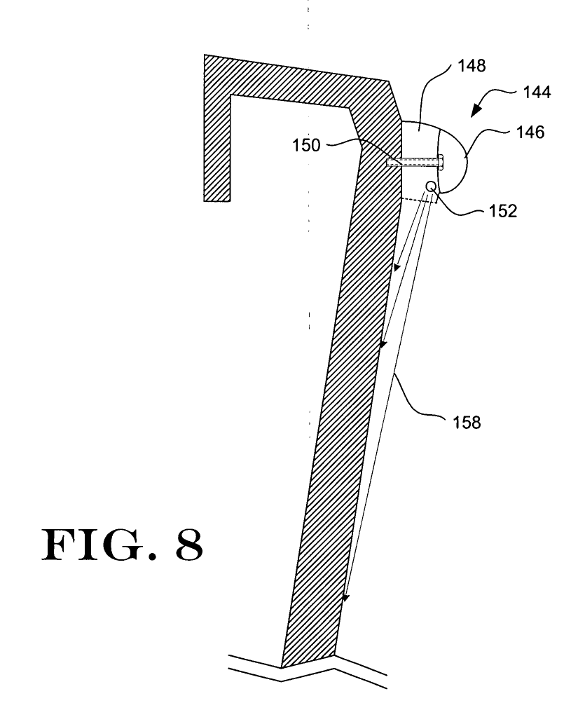

The elongated boat lighting apparatus 66 is shown mounted to the downward extending portion 62 just below the bumper assembly 70. The elongated boat lighting apparatus 66 includes at least one light source for producing a number of light rays as shown, and an elongated carrier for carrying the at least one light source. The elongated carrier is preferably at least partially transparent to allow the light rays produced by the one or more light source to exit the carrier. In the embodiment shown, the light rays exit the carrier in various directions including down to the downward extending portion 62 of the boat hull 60, horizontally away from the boat hull 60, and upward toward the bumper assembly 70. However, in some embodiments, a redirector (not shown) may be positioned adjacent the top and outer side of the carrier to redirect substantially all of the light rays to the downward extending portion 62 of the boat hull 60. The redirector may include, for example, a separate shield placed around the top and outer side of the carrier, a reflective coating positioned on the top and outer side surface of the carrier, or portions of the carrier may be made non-transparent. Alternatively, or in addition, the elongated boat lighting apparatus 66 may be incorporated into the bumper assembly 70, similar to that shown in FIG. 8.

It is contemplated that the one or more light sources 88 (as well as the other light sources referenced throughout the drawings) may be any type of light source including an incandescent light source, a fluorescent light source, a light emitting diode (LED), any type of laser including one or more vertical cavity surface emitting lasers (VCSEL), a phosphor material, a glow in the dark material, or any other type of light source, either active or passive, that is capable of producing visible light.

In some embodiments, the one or more light sources may include an elongated light source, such as an electro-luminescent wire. One such electro-luminescent wire is commercially available from Solution Industries, located in Cypress, Tex., under the Trademark Flex Wire®. Another such electro-luminescent wire is commercially available from ELAM Electro-luminescent Industries Ltd., located in Jerusalem, Israel, under the Trademark LyTec™. Alternatively, or in addition, the one or more light sources may be a string of light sources, such as a string of incandescent light sources. One such string of light sources is available from Light Tech, Inc., located in Grand Rapids, Mich.

It is also contemplated the one or more light sources may include a light guide, such as a solid or multi-strand fiber optic cable or any other type of light transmitting medium that can transmit light rays. When so provided, the actual source of light may be located remotely, if desired, and coupled to the fiber optic cable or other type of light transmitting medium that can deliver the light rays to the desired location. One particularly suitable fiber optic cable is a linear emitting fiber, which emits light out of the side of the fiber. One such linear emitting fiber is available from Lumenyte International Corporation, Irvine, Calif., under the Trademark STA-FLEX® LEF™ Linear Emitting Fiber. More information on Linear Emitting Fibers can be found in, for example, U.S. Pat. Nos. 6,289,150, 6,282,355, 6,251,311, 5,987,199, 5,937,127, 5,903,695, RE36,157, all of which are incorporated herein by reference. Traditional fiber optical cable may also be used, if desired.

It is contemplated that in some embodiments, the light source may include a UV stabilizer, UV absorber and/or UV filter. For example, some commercially available electro-luminescent wires include a polymer coating or sleeve over the electro-luminescent material. It is contemplated that the polymer coating or sleeve may include a UV stabilizer, UV absorber and/or UV filter to help limit the deterioration of the polymer coating and/or electro-luminescent material. A preferred UV absorber is Sanduvor PR-25, available from Clariant Corp., Charlotte, N.C., which operates using photoreactive chemistry. However, other UV stabilizers, UV absorbers, and UV filters may be used, as desired.

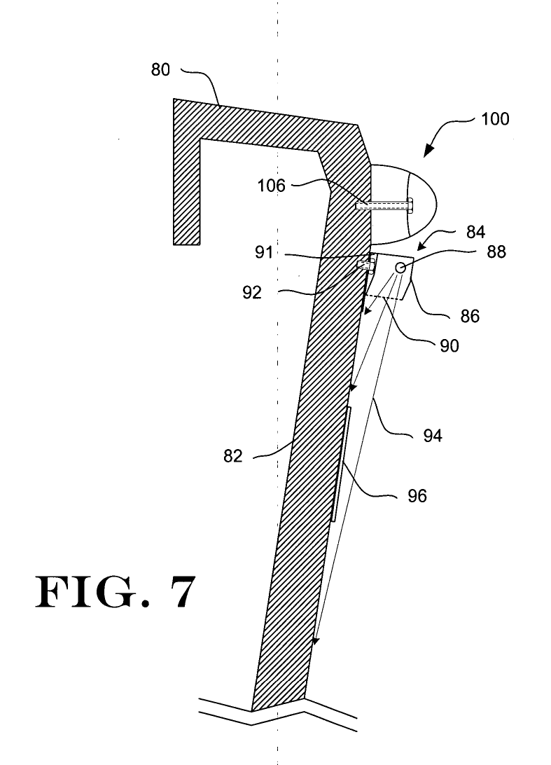

FIG. 7 is a partial cross-sectional side view of a boat hull having another illustrative boat lighting apparatus. The boat hull 80 includes a generally downward extending portion 82 that extends to an expected water line. The boat hull 80 may also include a bumper assembly 100 for protecting the boat hull 80 from docks or the like. The bumper assembly 100 is shown mounted on a top portion of the downward extending portion 82 of the boat hull 80 via mounting bolt 106.

In the illustrative embodiment, boat lighting apparatus 84 is mounted to the downward extending portion 82, just below the bumper assembly 100. The boat lighting apparatus 84 includes one or more light sources 88 for providing light rays, a housing 86 for carrying the light source 88, and a mount 91 for mounting the housing 86 to the boat. The mount 91 is shown bolted to the side of the downward extending portion 82 of the hull via a bolt or screw 92. It is contemplated, however, that any number of means may be used to attach the mount to the boat including an adhesive or the like.

The housing 86 preferably has at least one opening 90 for directing the light rays 94 to at least a portion of the hull of the boat. In the illustrative embodiment shown, the housing 86 includes a wall that extends around three sides of the light source 88, leaving the one opening 90 on the fourth downward side. Such a configuration not only helps direct the light rays 94 toward the hull of the boat, but also helps prevent at least a portion of the light rays from traveling laterally away from the hull of the boat. The inside surface of the housing 86 may be reflective, and may be shaped to help redirect the light rays 94 in a downward direction toward the hull of the boat. The housing 86 may also include a bracket (not shown) for carrying the one or more light sources 88.

A transparent or semi-transparent plate may be positioned across the opening 90. The transparent or semi-transparent plate may be constructed as a lens or the like to help redirect and/or focus the light on the hull of the boat. It is also contemplated that the transparent or semi-transparent plate may include a pattern provided thereon or therein to cause an image to be projected onto the hull of the boat. Finally, the transparent or semi-transparent plate may help protect the one or more light sources 88 from water or other undesirable environmental conditions.

In some embodiments, the transparent or semi-transparent plate may include a UV stabilizer, UV absorber and/or UV filter. The remainder of the housing 86 may also include a UV stabilizer, UV absorber and/or UV filter. This may help prevent deterioration of the transparent or semi-transparent plate and/or housing 86, and may limit the amount of UV radiation that engages the one or more light sources. This may help extend the life of the light assembly, especially when exposed to sun light. It is contemplated that UV stabilizers, UV absorbers and/or UV filters may be applied to the carriers, housings, light sources, and other parts of the various embodiments disclosed herein, as desired.

To enhance the illumination of the hull of the boat, it is contemplated that a reflective medium 96 may be provided in or on the outer surface of the boat as shown. The reflective medium preferably helps reflect the light rays 94 laterally outward and away from the hull of the boat to enhance the visibility of the boat. It is contemplated that the reflective medium may be patterned to form an image. The image may be, for example, the name of the boat, advertising logos or any other desired image.

FIG. 8 is a partial cross-sectional side view of a boat hull with yet another boat lighting apparatus. This embodiment is similar to that shown in FIG. 7, but has the boat lighting apparatus integrated or incorporated into the bumper assembly 144. The bumper assembly 144 includes a flexible bumper guard 146 attached to an elongated housing 148. The elongated housing 148 is attached to the hull of the boat via a bolt or screw 150. The elongated housing 148 preferably has a cavity therein for receiving one or more light sources 152. The cavity is preferably open along the lower surface thereof to allow the light rays 158 to illuminate the hull of the boat.

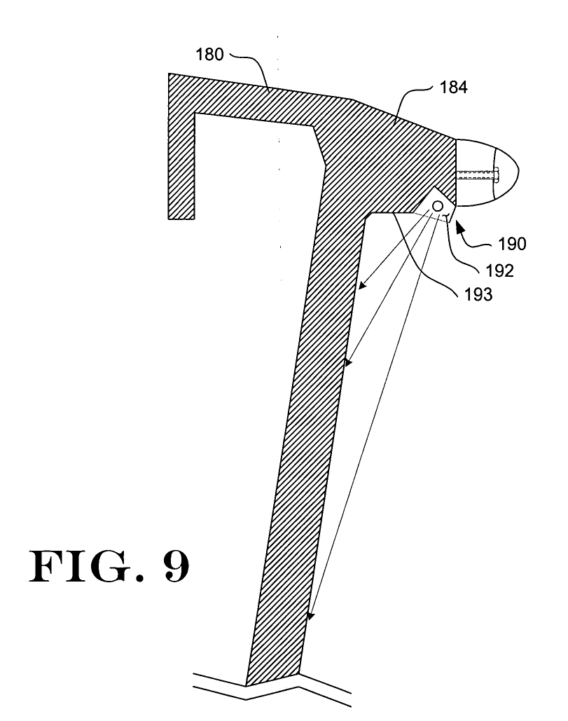

FIG. 9 is a partial cross-sectional side view of a boat hull having a boat lighting apparatus incorporated into an outward extending hull portion. In this embodiment, the boat hull 180 includes an outward extending hull portion 184. The boat lighting apparatus 190 may then be provided in a cavity 192 provided in the lower surface of the outward extending hull portion 184. Alternatively, a boat lighting apparatus similar to that shown in FIG. 7, for example, may be mounted to a lower surface 193 of the outward extending hull portion 184 to illuminate the hull of the boat.

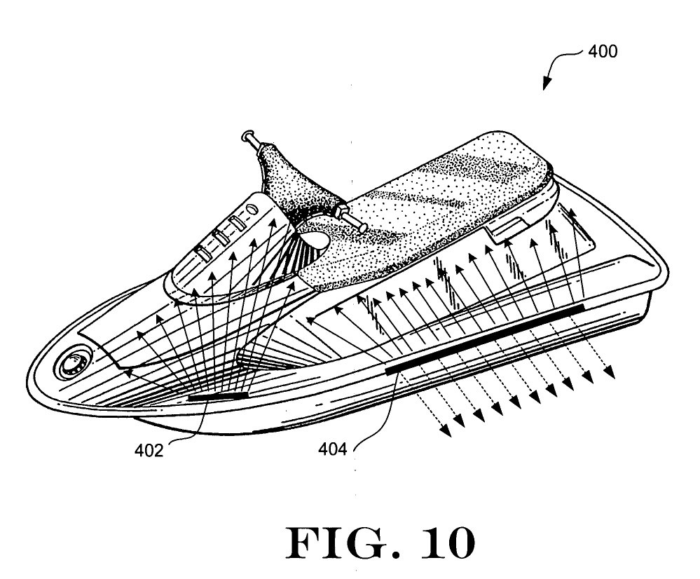

FIG. 10 is a perspective view of a personal watercraft having one or more boat lights 402 and 404 mounted thereto. Boat lights 402 and 404 are preferably similar to that described herein and preferably illuminate at least a portion of the side surfaces of the personal watercraft. While a personal watercraft is shown in FIG. 10, it is contemplated that the boat lighting apparatus of the present invention may be used to light the side surfaces of airplanes, snowmobiles, automobiles, all terrain vehicles, or any other type of “vehicle” as that term is used in the most general sense, to increase their visibility to outside observers.

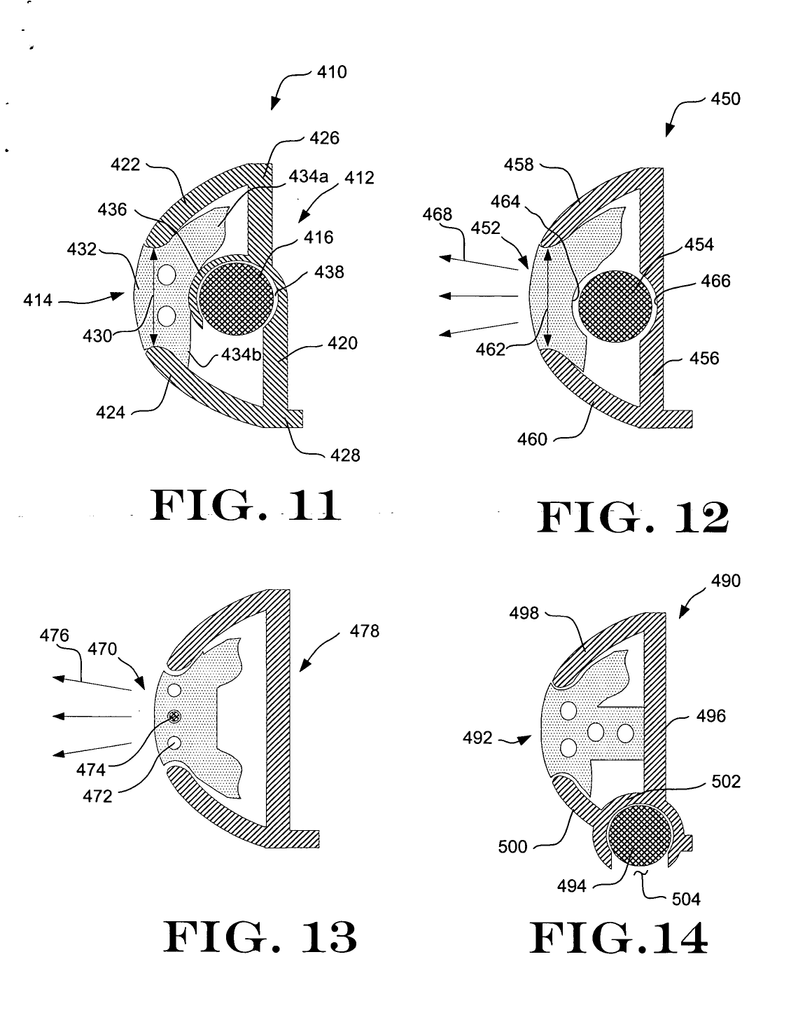

FIG. 11 is a cross-sectional side view of another illustrative lighting apparatus of the present invention. The illustrative lighting apparatus is generally shown at 410, and includes a carrier 412, a bumper member 414, and a light source 416. The carrier 412 includes a back support 420, a top support 422 and a bottom support 424, as shown. The terms “back”, “bottom” and “top” are only used herein as relative terms to help describe the Figures. They are not intended to imply that the bottom support 420 must be below the top support 422 when the carrier 412 is actually mounted to an object. The top support 422 and bottom support 424 are shown extending from the top 426 and bottom 428 ends, respectively, of the back support 420 in a leftward direction. The top support 422 and bottom support 424 terminate to define a gap or slot 430 therebetween.

The bumper member 414 is shown positioned in the gap or slot 430. The bumper member 414 preferably has an outer facing portion 432 that is sized to fit into the slot 430, and one or more inner facing legs 434a and 434b that extend into the cavity formed by the top support 422 and bottom support 424 of the carrier 412. The one or more legs 434a and 434b preferably have a dimension that exceeds the lateral dimension of the slot 430, which helps secure the bumper member 414 to the carrier 412. In some embodiments, the bumper member 414 and/or carrier 412 are at least somewhat deformable, so that the bumper member 414 and/or the elongated carrier 412 can or must be elastically deformed (e.g. bent or otherwise deformed) to allow the one or more legs 434a and 434b of the bumper member 414 to slip through the slot 430. The bumper member 414 may also have one or more holes or lumens 440a and 440b. These holes or lumens 440a and 440b may decrease the rigidness of the bumper member 414, as desired.

In one illustrative embodiment, the back support 420, top support 422 and bottom support 424 of the carrier 412 are integrally formed by extrusion, although this is not required. In some embodiments, the back support 420, top support 422 and bottom support 424 of the carrier 412 are made from a relatively rigid material, such as Vinyl, PVC, aluminum, or any other suitable material.

The bumper member 414 may also be formed by extruding a material such as Vinyl, PVC, rubber, or any other suitable material. However, like above, this is not required. Preferably, the bumper member 414 is formed from a softer material than the carrier 412, but this is also not required.

In the illustrative embodiment shown in FIG. 11, the carrier 412 has an inner support member 436 that is curved to form a light receiving opening or cavity 438. In the illustrative embodiment, the inner support member 436 is adapted to receive and secure an elongated light source 416. In a preferred embodiment, the elongated light source 416 is an electro-luminescent wire or a Linear emitting fiber, as detailed above. However, it is contemplated that the elongated light source 416 may be any type of light source, including those discussed above.

The inner support member 436 may be at least partially transparent or non-transparent. When the inner support member 436 is non-transparent, the light emitted by the light source is directed in a downward direction toward the bottom support 424 of the carrier 412. When so provided, at least a portion of the bottom support 424 is preferably at least partially transparent. This may be accomplished by, for example, forming the bottom support 424 or a portion thereof from a material that is at least semi-transparent. Alternatively, holes or slots may be provided in the bottom support 424 to allow the light to pass through the bottom support 424. In some embodiments, the holes or slots may be spaced holes or slots that are spaced along the length of the bottom support 424. Such spaced holes or slots may be formed by, for example, periodically interrupting the extrusion material along the bottom support 424. Other methods may also be used, such as cutting, drilling or otherwise forming spaced holes or slots. Spaced holes or slots may be used in other embodiments described herein, if desired.

In some embodiments, the back support 420, top support 422 and bottom support 424 may be formed from a transparent or semi-transparent material. In other embodiments, only selected portions may be formed from a transparent or semi-transparent material. For example, the bottom support 424, or portion thereof, may be formed from a transparent or semi-transparent material. In this latter case, the back support 420, top support 422 and bottom support 424 may be co-extruded using a non-transparent and transparent or semi-transparent material, with the transparent or semi-transparent material corresponding to the portion that is to transmit light. Alternatively, the bottom support 424, or the portion thereof that is to pass light, may be separately formed and subsequently attached, if desired.

In another illustrative embodiment, the inner support member 436 or a portion thereof may be made from a transparent or semi-transparent material to pass light toward the bumper member 414. In this illustrative embodiment, the bumper member 414, or a portion thereof, may also be formed from a transparent or semi-transparent material. When so provided, the light from the light source 416 may pass through the inner support member 436, through the bumper member 414, and away from the carrier 412. In use, the back support 420 is preferably positioned adjacent a mounting surface and mounted thereto.

It is contemplated that the bumper member 414 and/or carrier 412, or parts thereof, may be made using materials of different colors, as desired. Also, it is contemplated that the light source may be selected to produce a desired color of light.

FIG. 12 is a cross-sectional side view of another illustrative lighting apparatus of the present invention. The illustrative lighting apparatus includes a carrier 450, a bumper member 452, and a light source 454. The carrier 450 includes a back support 456, a top support 458 and a bottom support 460, as shown. The top support 458 and bottom support 460 are shown extending from the top and bottom ends, respectively, of the back support 456 in a leftward direction. The top support 458 and bottom support 460 terminate to define a gap or slot 462 therebetween.

The bumper member 452 is shown positioned in the gap or slot 462, as described above. In the illustrative embodiment, the back surface 464 of the bumper member 452 and the front surface 466 of the back support 456 are shaped to form a light receiving channel, opening or cavity. In the illustrative embodiment, the light receiving channel, opening or cavity is adapted to receive and secure an elongated light source 454. It is contemplated that the elongated light source 454 may be any type of light source, including those identified herein.

The bumper member 452, or a portion thereof, is preferably formed from a transparent or semi-transparent material. When so provided, the light from the light source 454 may pass through the bumper member 452, and away from the carrier 450 as shown by lines 468.

FIG. 13 is a cross-sectional side view of another illustrative lighting apparatus in accordance with the present invention. In this illustrative embodiment, the bumper member 470 includes one or more holes, slots or lumens 472. A light source 474 is then positioned in one or more of the holes, slots or lumens 472. Only one light source 474 is shown in FIG. 13. The bumper member 470, or a portion thereof, is preferably formed from a transparent or semi-transparent material. When so provided, the light from the light source 474 may pass through the transparent or semi-transparent portion of the bumper member 470 and away from the carrier 478, as shown by lines 476.

When more than one light source 474 is provided, each light source 474 may be situated in a different one of the holes or lumens 472, but this is not required. Selected light sources may be selected to produce different colors. Alternatively, or in addition, the portion of the bumper member 470 adjacent selected light sources may be formed from materials of different colors. In some embodiments, this may provide the appearance of one or more stripes of colors along the bumper member 470.

FIG. 14 is a cross-sectional side view of another illustrative lighting apparatus in accordance with the present invention. In this illustrative embodiment, the lighting apparatus includes a carrier 490, a bumper member 492, and a light source 494. The carrier 490 includes a back support 496, a top support 498 and a bottom support 500, as shown. Like above, the top support 498 and bottom support 500 terminate to define a gap or slot for receiving the bumper member 492.

In some embodiments, the back support 496, top support 498 and bottom support 500 of the carrier are made from a relatively rigid material, such as Vinyl, PVC, aluminum, or any other suitable material. The bumper member 492 may also be formed by, for example, extruding a material such as Vinyl, PVC, rubber, aluminum or any other suitable material. However, like above, this is not required. Preferably, the bumper member 492 is formed from a softer material than the carrier, but this is also not required.

In the illustrative embodiment, the back support 496 and the bottom support 500 are joined together through a light carrying member 502. Although not shown in FIG. 14, it is contemplated that the back support 496 and the top support 498 may also be joined together through another light carrying member, if desired, to provide light in an upward direction. The light carrying member 502 preferably defines a channel, cavity or recess for receiving the light source 494. Preferably, the cavity or recess is sized to receive the light source and secure the light source 494 to the carrier 490. In the illustrative embodiment, the cavity or recess has a receiving slot 504 for receiving the light source 494. In a preferred embodiment, the light source 494 is an elongated light source such as an electro-luminescent wire or a Linear Emitting Fiber, as detailed above. However, it is contemplated that the light source 494 may be any type of light source, including those identified herein.

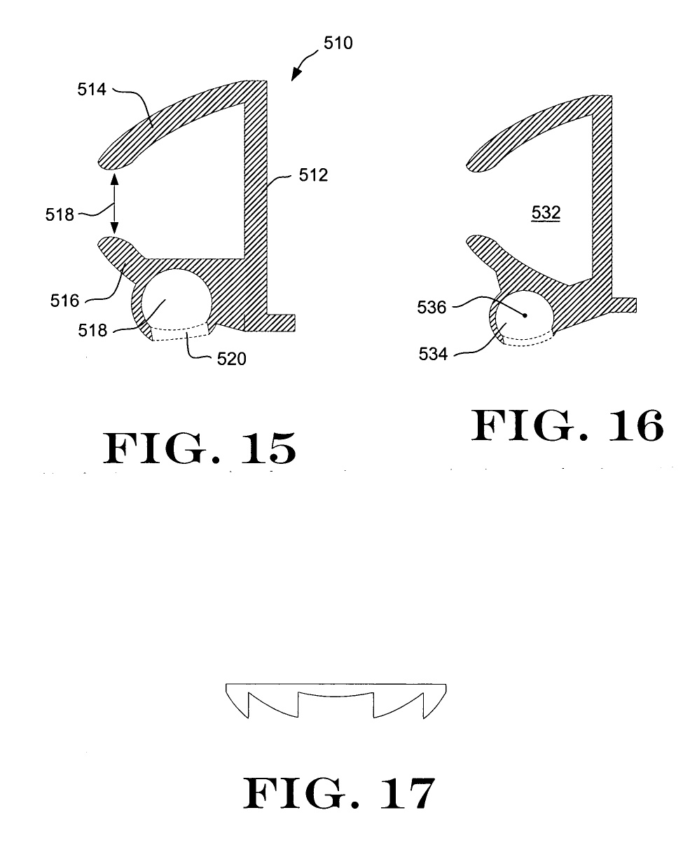

FIG. 15 is a cross-sectional side view of yet another illustrative lighting apparatus in accordance with the present invention. In this illustrative embodiment, the lighting apparatus includes a carrier 510. For simplicity, the bumper member and light source are not shown. The carrier 510 includes a back support 512, a top support 514 and a bottom support 516, as shown. Like above, the top support 514 and bottom support 516 terminate to define a gap or slot 518 for receiving a bumper member.

In the illustrative embodiment, the bottom support 516 is shaped to provide a light carrying channel, cavity or recess 518. The light carrying channel, cavity or recess 518 preferably is sized to receive a light source. In the illustrative embodiment, the channel, cavity or recess 518 preferably has a transparent or semi-transparent portion 520 for passing light in a downward direction. The transparent or semi-transparent portion 520 may be co-extruded with the rest of the carrier 510, which may be made from a non-transparent material, if desired. Alternatively, the transparent or semi-transparent portion 520 may be formed separately, and subsequently secured to the bottom support 516.

In either case, and in some embodiments, the transparent or semi-transparent portion 520 may be shaped to form a Fresnel lens, as shown in FIG. 17. A Fresnel lens may help collect and focus the light that is emitted by the light source. A Fresnel lens may also help minimize the amount of absorption in the lens by reducing the thickness of the lens. Other lens shapes may also be used.

FIG. 16 is a cross-sectional side view of yet another illustrative lighting apparatus in accordance with the present invention. This illustrative embodiment is similar to the embodiment shown in FIG. 15. However, the bottom support 530 is shaped to provide a larger cavity 532 for receiving a bumper member. Further, the wall thickness of the bottom support 530 is maintained along its length. In the illustrative embodiment, this is accomplished by moving the central axis 536 of the light carrying cavity or recess 534 further down and/or away from the carrier.

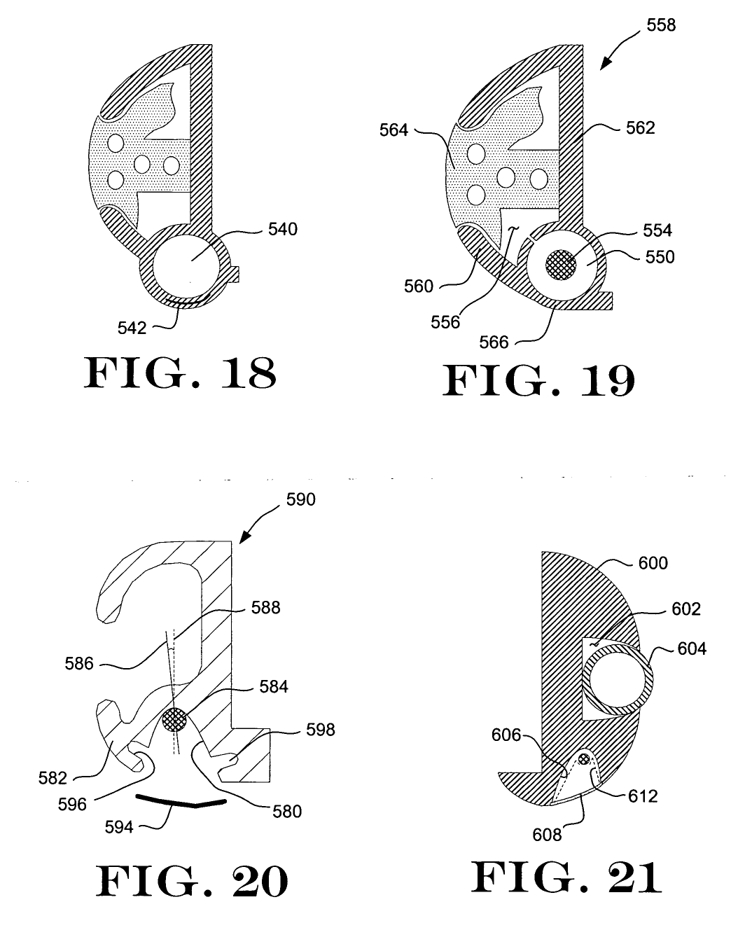

FIG. 18 is a cross-sectional side view of another illustrative lighting apparatus in accordance with the present invention. This illustrative embodiment is similar to the embodiment shown in FIG. 14. However, the cavity or recess 540 does not have a receiving slot for receiving the light source 494. Instead, a wall encircles the cavity or recess 540. In one embodiment, a lower portion 542 of the wall encircling the cavity or recess 540 is formed from a transparent or semi-transparent material. The remainder of the wall encircling the cavity or recess 540 may be at least partially reflective, but this is not required.

FIG. 19 is a cross-sectional side view of another illustrative lighting apparatus in accordance with the present invention. This illustrative embodiment is similar to that shown in FIG. 18. However, the cavity or recess 550 has a receiving slot 552 for receiving a light source 554. The receiving slot 552 is shown opening into the inner cavity 556 of the carrier 558. To install the light source 554 into the cavity or recess 550, the bottom support 560 may be pulled away from the back support 562. Preferably, the bottom support 560 and/or back support 562 temporarily elastically deform to open the receiving slot 552 and receive the light source 554. Once the light source 554 is in the cavity or recess 550, the bottom support 560 may be returned or nearly returned to its original position relative to the back support 562. The bumper member 564 is then installed, also preferably by elastic deformation of the bumper member 564 and/or carrier 558. Like the embodiment shown in FIG. 18, it is contemplated that a lower portion 566 of the wall encircling the cavity or recess 550 may be formed from a transparent or semi-transparent material. The remainder of the wall encircling the cavity or recess 550 may be at least partially reflective, but this is not required.

FIG. 20 is a cross-sectional side view of yet another illustrative lighting apparatus in accordance with the present invention. In this illustrative embodiment, a parabolic shaped recess or cavity 580 is formed in the bottom support 582. A parabolic shape may help collect and direct the light emitted by the light source 584 in a particular direction, particular if the walls of the parabolic shaped recess or cavity 580 are at least partially reflective. In some embodiments, the axis 586 of the parabolic shaped recess or cavity 580 may be offset relative to a vertical axis 588 to help direct the light rays toward an object, such as an object that the carrier 590 is mounted.

A lens or cover 594 may be provided to cover the parabolic shaped recess or cavity 580, if desired. In some illustrative embodiments, one or more receiving slots 596 and 598 may be provided for receiving the edges of the lens or cover 594. In other illustrative embodiments, the lens or cover may be co-extruded or otherwise integrally formed or securely attached to the carrier 590.

FIG. 21 is a cross-sectional side view of another illustrative lighting apparatus in accordance with the present invention. This illustrative embodiment includes a “D” shaped carrier 600 having a bumper receiving slot 602. A bumper member 604 may be provided in the bumper receiving slot 602. The bumper member 604 may be an elongated tube that is sized to fit within the bumper receiving slot 602, as shown. Like the illustrative embodiment of FIG. 20, a parabolic shaped recess or cavity 606 is provided in a bottom portion of the “D” shaped carrier 600. A lens or cover 608 may be provided to cover the parabolic shaped recess or cavity 606, if desired. In the illustrative embodiment, the lens or cover is co-extruded or otherwise integrally formed or securely attached to the “D” shaped carrier 600, but this is not required.

A light source 610 is shown positioned in the parabolic shaped recess or cavity 606. One or more light source support members 612 may be provided to help secure the light source 610 in the parabolic shaped recess or cavity 606. In some embodiments, the one or more light source support members 612 may help secure the light source 610 at or near the focal point of the parabolic shaped recess or cavity 606.

FIG. 22 is a cross-sectional side view of yet another illustrative lighting apparatus in accordance with the present invention. In this illustrative embodiment, a carrier 620 is provided with a light receiving channel, cavity or recess 622 formed in the bottom support 624. A light source 626 is positioned within the light receiving channel, cavity or recess 622. The illustrative carrier 620 has a back support 626 that is adapted to be adjacent a mounting surface.

A mating member 628 is also provided. The mating member 628 may include a back support 630 and a lens or cover portion 632. The mating member 628 preferably mates with the back support 626 of the carrier 620. The lens or cover portion 632, or a portion thereof, preferably is shaped to cover the light receiving cavity or recess 622 formed in the bottom support 624. A slot may be provided in the bottom support 624 of the carrier 620 to receive a lip 634 of the lens or cover portion 632, if desired.

In one illustrative embodiment, the carrier 620 may be made from a material that is non-transparent and at least partially reflective. The mating member 628 may be made from a material that is at least semi-transparent. Alternatively, only the lens or cover portion 632 of the mating member 628 may be made from a material that is at least semi-transparent. In other embodiments, the carrier 620 may be made from a material that is at least partially transparent, and the mating member may be made from a material that is non-transparent and at least partially reflective. In any case, it is contemplated that the mating member 628 may be made separate from the carrier 620.

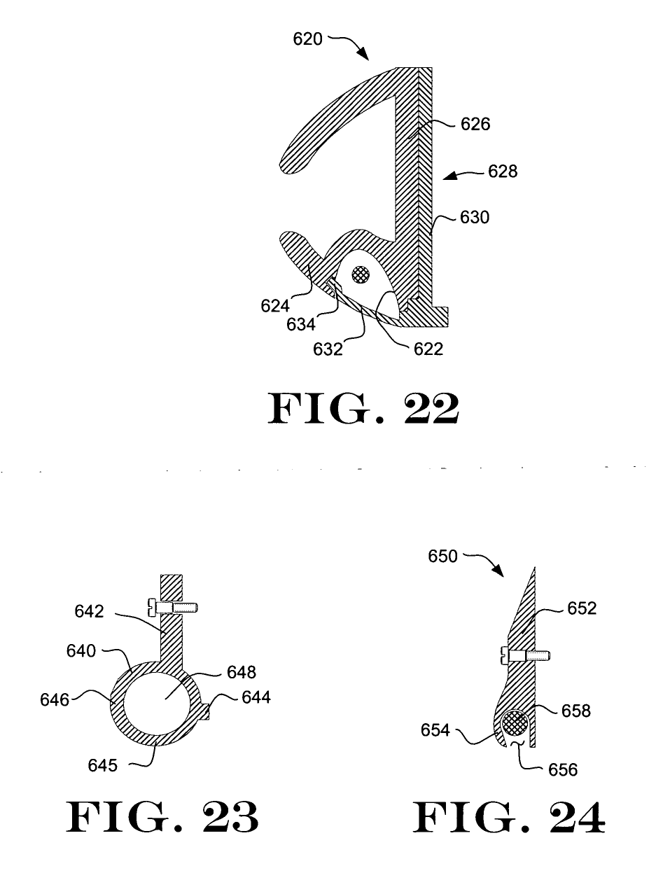

FIG. 23 is a cross-sectional side view of another illustrative lighting apparatus in accordance with the present invention. In this illustrative embodiment, no separate bumper member is provided. Instead, an elongated tube 640 is provided with a mounting support 642 extending therefrom. A spacer support 644 may also be provided to help space the tube 640 from the mounting surface. A light source (not shown) can be positioned within the inner lumen 648 of the tube 640, as desired. At least a portion of the tube 640 is preferably at least semi-transparent to allow at least some of the light rays from the light source to exit from the tube 640. In one embodiment, portion 645, portion 646, or both, are at least semi-transparent. In some embodiments, the tube 640 is adapted to prevent light rays from traveling in a first direction away from the tube 640 while allowing light rays to travel in a second different direction away from the tube 640.

FIG. 24 is a cross-sectional side view of yet another illustrative lighting apparatus in accordance with the present invention. Like the embodiment shown in FIG. 23, this illustrative embodiment also does not have a separate bumper member. Instead, an elongated member 650 is provided with a mounting region 652 and a light source receiving region 654. The light source receiving region 654 includes a light source receiving cavity or recess 656, which receives a light source 658. The elongated member 650 may be made from a non-transparent or at least semi-transparent material, as desired.

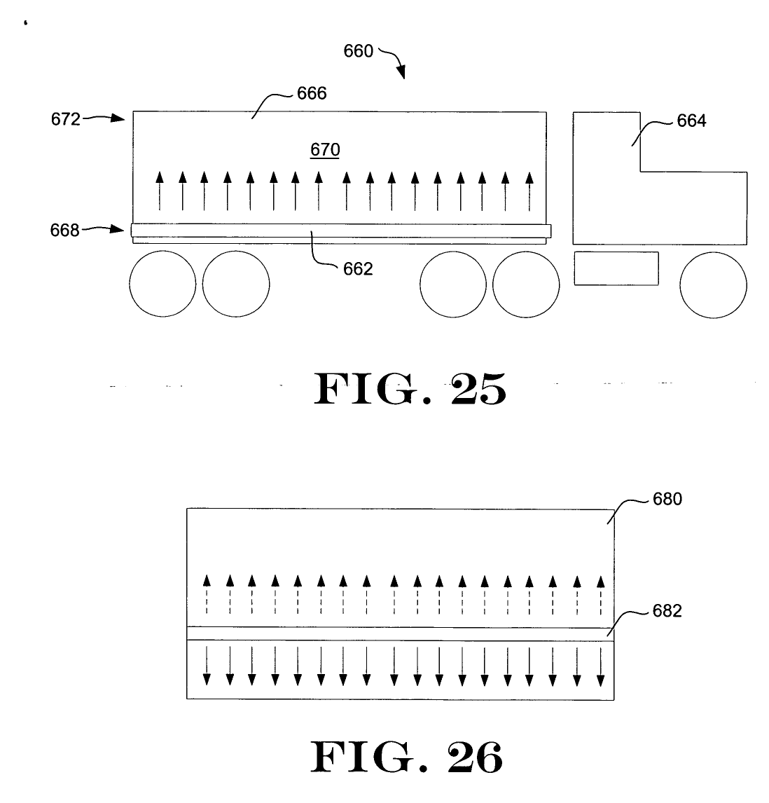

As indicated above, it is contemplated that some embodiments of the present invention may be used to illuminate vehicles, such as boats (including barges), cars, trucks, etc., preferably by illuminating one or more side surfaces of the vehicle. The side surfaces of many vehicles provide a relatively large area that, when illuminated, can significantly increase the visibility of the vehicle, especially at night. It is believed that by providing such visibility, vehicle safety can be significantly improved. FIG. 25 is a schematic view of a truck 660 with an illustrative lighting apparatus 662 mounted to the side thereof. The illustrative truck 660 includes a cab 664 and a trailer 666, with an illustrative lighting apparatus 662 mounted along a lower edge 668 of the trailer 666. The illustrative lighting apparatus 662 may be similar to those described herein, and may distribute light in an upward direction to illuminate at least a portion of the side surface 670 of the trailer 666. The lighting apparatus 662 may extend around the perimeter of the trailer 666, if desired.

In some embodiments, the illustrative lighting apparatus 662 may include a bumper, to help provide a level of protection to the lower edge 668 of the trailer 666. Such protection may be desirable when, for example, the truck 660 is maneuvering into a loading dock or the like. While the illustrative lighting apparatus is shown mounted to a truck trailer 666, it may also be mounted to the box of a straight truck, or even to the cab 664, as desired. In addition, it is contemplated that the illustrative lighting apparatus 662 may be mounted to an upper edge 672 of the cab 664 or trailer 666, and/or at an intermediate location, as desired.

FIG. 26 is a schematic view of an object, generally shown at 680, with an illustrative lighting apparatus 682 mounted to the side thereof. The object 680 may by any type of object. For example, the object 680 may include retail and/or store shelving and/or equipment (including grocery store shelving and/or equipment such as refrigerated shelving), bars, desks, counters, walls such as in hallways or rooms, ceilings, railings, steps, and/or any other object or surface, as desired. The illustrative lighting apparatus 682 is shown providing illumination in both an upward and downward direction, although in some embodiments, illumination may be only provided in one direction, including in an outward direction. In some embodiments, the lighting apparatus 682 may include a bumper, such as described above. When so provided, the lighting apparatus 682 may help provide a level of protection to the object 680.

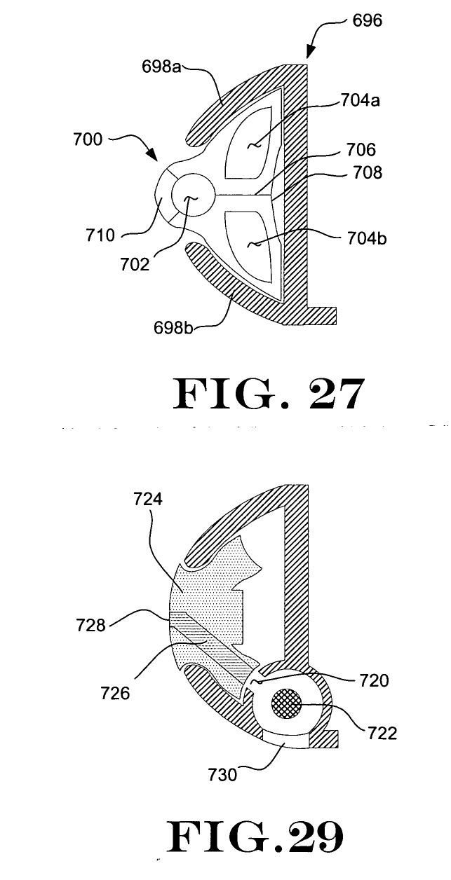

FIG. 27 is a cross-sectional side view of another illustrative lighting apparatus in accordance with the present invention. In this illustrative embodiment, an elongated carrier 696 is provided. Like some of the embodiments above, the elongated carrier 696 includes two legs 698a and 698b that form a slot or opening for receiving an elongated bumper member or insert 700. In some embodiments, the elongated carrier 696 and/or the elongated bumper member 700 must be elastically deformed (e.g. bent or otherwise deformed) for the elongated bumper member 700 to slip into the slot. To help aid the insertion of the elongated bumper member 700 into the slot of the elongated carrier 696, the elongated bumper member 700 may include one or more relief lumens 704a and 704b, if desired.

The elongated bumper member 700 may include a cavity 702. The illustrative cavity 702 is adapted to receive an elongated light source (not shown), such as an electro-luminescent wire, a linear emitting fiber, or any other suitable elongated light source. The elongated bumper member 700, or a portion thereof, may be formed from a transparent or semi-transparent material. The transparent or semi-transparent material preferably defines at least part of the cavity 702, and extends to an outer surface of the elongated bumper member 700. In the embodiment shown, portion 710 may be formed from a transparent or semi-transparent material. When so provided, the light from the elongated light source may pass through the transparent or semi-transparent portion of the elongated bumper member 700 and away from the lighting apparatus.

To help aid with the insertion of the elongated light source into the cavity 702, a slit 706 may be provided. The slit may extend from the cavity 702 to an outer surface 708 of the elongated bumper member 700. In the embodiment shown, the slit extends from the cavity 702 to the outer surface 708 adjacent the back of the carrier 698, but this is not required.

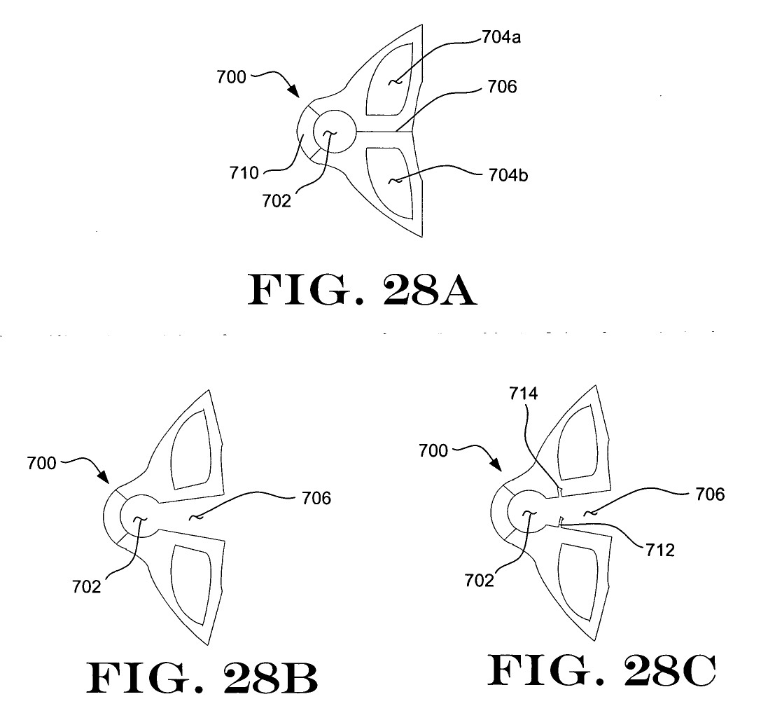

FIG. 28A is a cross-sectional side view of the elongated bumper member (or insert) 700 of FIG. 27, with the slit 706 in the closed position. In one embodiment, the slot of the elongated carrier 698 as well as the shape and size of the elongated bumper member 700 are adapted so that when the elongated bumper member 700 is inserted into the slot of the elongated carrier 698, the elongated carrier 698 provides a closing force to keep the slit 706 in, or nearly in, the closed position.

FIG. 28B is a cross-sectional side view of the elongated bumper member (or insert) of FIG. 27, with the slit in an open position. In the illustrative embodiment, the elongated bumper member 700 is normally in the closed position, as shown in FIG. 28A. To place the elongated bumper member 700 in the open position, the elongated bumper member 700 is at least partially elastically deformed (e.g. bent or otherwise deformed) by applying an outward force. Alternatively, the elongated bumper member 700 may normally be in the open position, as shown in FIG. 28B. To place the elongated bumper member 700 in the closed position, the elongated bumper member 700 is at least partially elastically deformed (e.g. bent or otherwise deformed) by applying an inward force. In either case, the elongated bumper member 700 may more easily receive an elongated light source (not shown) through the slit 706 when in the open position.

FIG. 28C is a cross-sectional side view of the insert of FIG. 27, with the slit in an open position and with a slit latching mechanism. In the illustrative embodiment, the slit latching mechanism includes a leg with a tooth 712, along with a matching receiving opening 714. As the elongated bumper member 700 is moved into the closed position, the leg 712 slides into the matching receiving opening 714, and the tooth 712 snaps into a corresponding opening in the receiving opening. The latching mechanism may help the elongated bumper member 700 remain in the closed position.

FIG. 29 is a cross-sectional side view of another illustrative lighting apparatus in accordance with the present invention. This illustrative embodiment is similar to that shown in FIG. 19. However, the receiving slot 720 for receiving the light source 722 may be wider, and may be used to direct light from the light source 722 to the elongated bumper member 724. The elongated bumper member 724 may then include a transparent or semi-transparent portion 726 that directs the light received through the receiving slot 720 to an outer surface 728 of the elongated bumper member 724. In some embodiments, the entire elongated bumper member 724 may be made from a transparent or semi-transparent material. In other embodiments, only a portion of the elongated bumper member 724 is transparent or semi-transparent portion, as shown. In either case, the embodiment shown in FIG. 29 may allow light from the light source 722 to be directed to multiple locations, such as down through a transparent or semi-transparent window 730 as well as to the outer surface 728 of the elongated bumper member 724.

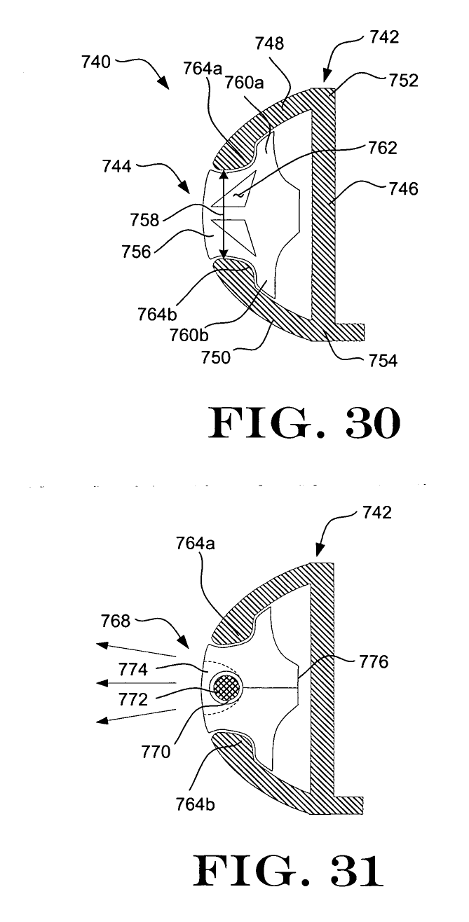

FIG. 30 is a cross-sectional side view of an illustrative rub-rail with nubs in accordance with the present invention. The illustrative rub-rail is generally shown at 740, and includes a carrier 742 and an elongated bumper member 744. The carrier 740 includes a back support 746, a top support leg 748 and a bottom support leg 750. The top support leg 748 and bottom support leg 750 are shown extending from the top 752 and bottom 754 ends, respectively, of the back support 746 in a leftward direction. The top support leg 748 and bottom support leg 750 terminate to define a gap or slot 758 therebetween.

The bumper member 744 is shown positioned in the gap or slot 758. The bumper member 744 preferably has an outer portion 756 that is sized to fit into the slot 758, and one or more inner facing legs 760a and 760b that extend into the cavity formed by the top support leg 748 and bottom support leg 750 of the carrier 742. The one or more legs 760a and 760b preferably have a dimension that exceeds the lateral dimension of the slot 758, which helps secure the bumper member 744 to the carrier 742. In some embodiments, the bumper member 744 and/or carrier 742 are at least somewhat elastically deformable, so that the bumper member 744 and/or the elongated carrier 742 can or must be elastically deformed (e.g. bent or otherwise deformed) to allow the one or more legs 760a and 760b of the bumper member 744 to slip through the slot 758. The bumper member 744 may also have one or more relief holes or lumens, such as relieve hole or lumen 762. Such relief holes or lumens may decrease the rigidness of the bumper member 744, as desired.

One or both of the top support leg 748 and bottom support leg 750 of the carrier 742 may have a nub, such as nub 764a and/or 764b. These nubs preferably extend inward into the cavity formed by the carrier 742. For example, nub 764a of the top support leg 748 is shown extending down into the cavity of the carrier 742 toward the bottom support leg 750. Likewise, nub 764b of the bottom support leg 750 is shown extending up into the cavity of the carrier 742 toward the top support leg 748.

In the illustrative embodiment, the top support leg 748 has an increased thickness at nub 764a, and the bottom support leg 750 has an increased thickness at nub 764b. In other embodiments, however, the thickness may remain relatively constant along the length of the top and/or bottom support legs, with both the inner surface and outer surface of the support legs extending inwardly to form the corresponding nub. Although the nubs 764a and 764b are shown near the distal end of the corresponding support leg away from the back member 746, it is contemplated that the nubs may be placed anywhere along the top and/or bottom support legs 748 and 750, and/or along the back member 746 as desired. In addition, multiple nubs may be placed along one or more of the top support leg, bottom support leg and/or back support 746, as desired. The elongated bumper member 744 preferably is shaped to accept the one or more nubs provided on the top support leg, bottom support leg and/or back support, as shown.

FIG. 31 is a cross-sectional side view of an illustrative lighting apparatus with nubs in accordance the present invention. This embodiment is similar to that shown in FIG. 30, but the elongated bumper member 768 includes a cavity 770 for receiving a light source 772, as shown. The elongated bumper member 768 is shaped to accept the nubs 764a and 764b provided on the top support leg 748 and bottom support leg 750, respectively. That is, the elongated support member 768 includes an outer surface that is shaped to correspond to the inner surface of the carrier 742, including nubs 764a and 764b. As indicated above, nubs 764a and 764b do not need to be positioned at or near the distal end of the top support leg 748 and/or bottom support leg 750, but rather may be positioned anywhere along the top support leg 748, bottom support leg 750 and/or back support 746, depending on the application.

In the illustrative embodiment, the elongated support member 768 may be made from a transparent or semitransparent material, or alternatively only a portion 774 (indicated by a dashed line) of the elongated support member 768 may be made from a transparent or semitransparent material, with the remainder made from a substantially non-transparent material. In addition, the illustrative elongated support member 768 includes a slit that extends from the cavity 770 to the back outer surface 776 of the elongated support member 768 to aid in the insertion of the elongated light source 772 into the cavity 770.

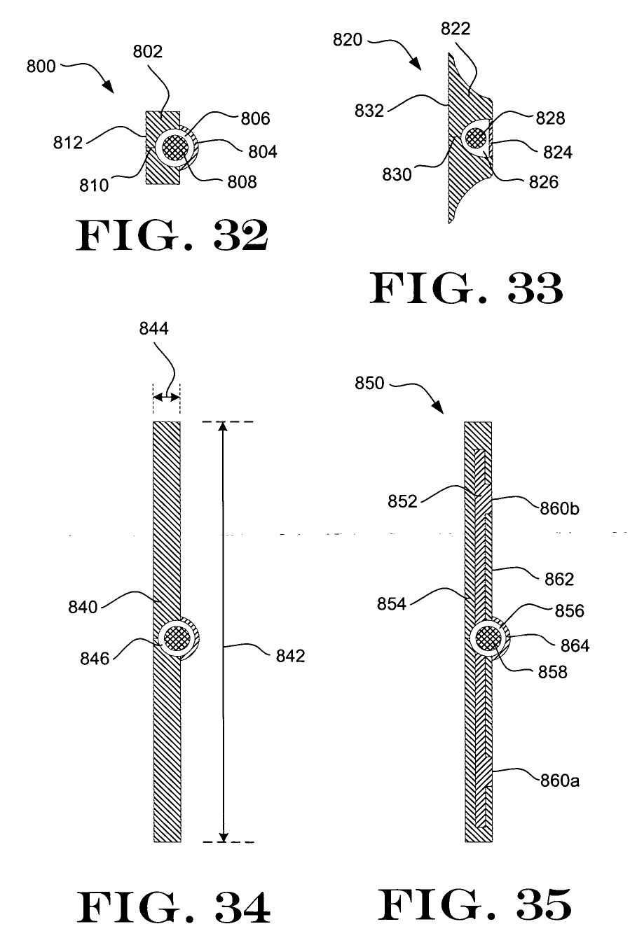

FIG. 32 is a cross-sectional side view of an illustrative lighting apparatus for receiving an elongated light source. The illustrative lighting apparatus is shown generally at 800, and includes a body 802. The body 802 includes a cover portion 804, which together form a cavity 806 for receiving an elongated light source 808. The body 802 may be transparent or semi-transparent, or substantially non-transparent, depending on the application. In one illustrative embodiment, the cover 804 is transparent or semi-transparent, and the remainder of the body 802 is substantially non-transparent. The cover 804 may be shaped to form a lens, but this is not required. In another illustrative embodiment, the cover 804 is substantially non-transparent and the remainder of the body 802 is transparent or semi-transparent.

It is contemplated that the cover 804 may be formed integrally with the remainder of the body 802 (such as by, for example, extrusion, co-extrusion, molding, or any other suitable method). Alternatively, the cover 804 may be formed separately from the remainder of the body 802. When formed separately from the remainder of the body 802, the cover 804 may be later secured to the remainder of the body 802 by, for example, a snapping mechanism, an adhesive, screws, or any other suitable securing method. In some embodiments, the cover 804 is secured to the remainder of the body 802 after the elongated light source is inserted into the cavity 806.

In some embodiments, the body 802 may include a slit 810 that extends from the cavity 806 to an outer surface of the body 802, such as outer surface 812. The slit 810 may be moved to an open position, by for example applying an external outward force, which may help aid in the insertion of the elongated light source 808 into the cavity 806 through the slit 810. Like other embodiments, it is contemplated that the illustrative lighting apparatus 800 may be mounted to, for example, any object including a boat, retail and/or store shelving and/or equipment (including grocery store shelving and/or equipment such as refrigerated shelving), bars, desks, counters, walls such as in hallways or rooms, ceilings, railings, steps, and/or any other object or surface, as desired. The body 802 may help provide a level of protection to the object and/or a level of protection to the elongated light source.

FIG. 33 is a cross-sectional side view of another illustrative lighting apparatus for receiving an elongated light source. The illustrative lighting apparatus is shown generally at 820, and includes a body 822. The body 820 includes a cover portion 824, which together form a cavity 826 for receiving an elongated light source 828. In the illustrative embodiment, the cavity 826 is parabolic in shape, which in some embodiments, may help focus (by reflection) the light provided by the elongated light source 828 toward the cover portion 824. The body 822 may be transparent or semi-transparent, or substantially non-transparent, depending on the application. In one illustrative embodiment, the cover 824 is transparent or semi-transparent, and the remainder of the body 822 is substantially non-transparent. The cover 824 may be flat or shaped to form a lens, as desired. In another illustrative embodiment, the cover 824 is substantially non-transparent and the remainder of the body 822 is transparent or semi-transparent.

It is contemplated that the cover 824 may be formed integrally with the remainder of the body 822 (such as by, for example, extrusion, co-extrusion, molding, or any other suitable method). Alternatively, the cover 824 may be formed separately from the remainder of the body 822. When formed separately from the remainder of the body 822, the cover 824 may be later secured to the remainder of the body 822 by, for example, a snapping mechanism, an adhesive, screws, or any other suitable securing method. In some embodiments, the cover 824 is secured to the remainder of the body 822 after the elongated light source is inserted into the cavity 826.

In some embodiments, the body 822 may include a slit 830 that extends from the cavity 826 to an outer surface of the body 822, such as outer surface 832. The slit 830 may be moved to an open position, by for example applying an external outward force, which may help aid in the insertion of the elongated light source 828 into the cavity 826 through the slit 830. It is contemplated that the illustrative lighting apparatus 820 may be mounted to, for example, any object including boats, retail and/or store shelving and/or equipment (including grocery store shelving and/or equipment such as refrigerated shelving), bars, desks, counters, walls such as in hallways or rooms, ceilings, railings, steps, and/or any other object or surface, as desired. The body 822 may help provide a level of protection to the object and/or a level of protection to the elongated light source.

FIG. 34 is a cross-sectional side view of yet another illustrative lighting apparatus for receiving an elongated light source. This illustrative embodiment is similar to the embodiment shown in FIG. 33, but the body 840 has a height 842 that is substantially greater than the thickness 844. In addition, the body 840 extends a substantial distance beyond the cavity 846. In one example, the cavity may have a diameter on the order of 0.050 inches, and the height 842 of the body 840 may be on the order of 0.25 to 24 inches or more. In some embodiments, this may provide a relatively large protection area (represented by the height 842 of the body 840) to an object.

FIG. 35 is a cross-sectional side view of another illustrative lighting apparatus for receiving an elongated light source. This illustrative embodiment is similar to the embodiment of FIG. 34. However, the body 850 includes both a first material 852 that is at least semi-transparent and a second material 854 that is substantially non-transparent. The at least semi-transparent material 852 is shown extending from the cavity 856 that houses the elongated light source 858 to one or more outer surfaces 860a and 860b of the body 850. The at least semi-transparent material 852 thus at least partially defines the cavity 856 and accepts light therefrom. The light is then delivered down the at least semi-transparent material 852 to the illuminate the one or more outer surfaces 860a and 860b. In the illustrative embodiment, the outer surface 862 between the one or more outer surfaces 860a and 860b is substantially non-transparent, with the possible exception of cover portion 864, but this is not required.

It is contemplated that the one or more outer surfaces 860a and 860b may be flat or may be shaped to form a lens, depending on the application. In addition, it is contemplated that the at least semi-transparent material 852 may have a higher index of refraction than the substantially non-transparent material 854, but this is not required. This may promote greater total internal reflection of the light as it travels down the at least semi-transparent material 852, much like an optical fiber.

In one illustrative embodiment, the at least semi-transparent material 852 may be integrally formed with the substantially non-transparent material 854. For example, the at least semi-transparent material 852 may be co-extruded with the substantially non-transparent material 854. Alternatively, the at least semi-transparent material 852 may be separately formed from the substantially non-transparent material 854, and subsequently mechanically secured together, as desired.

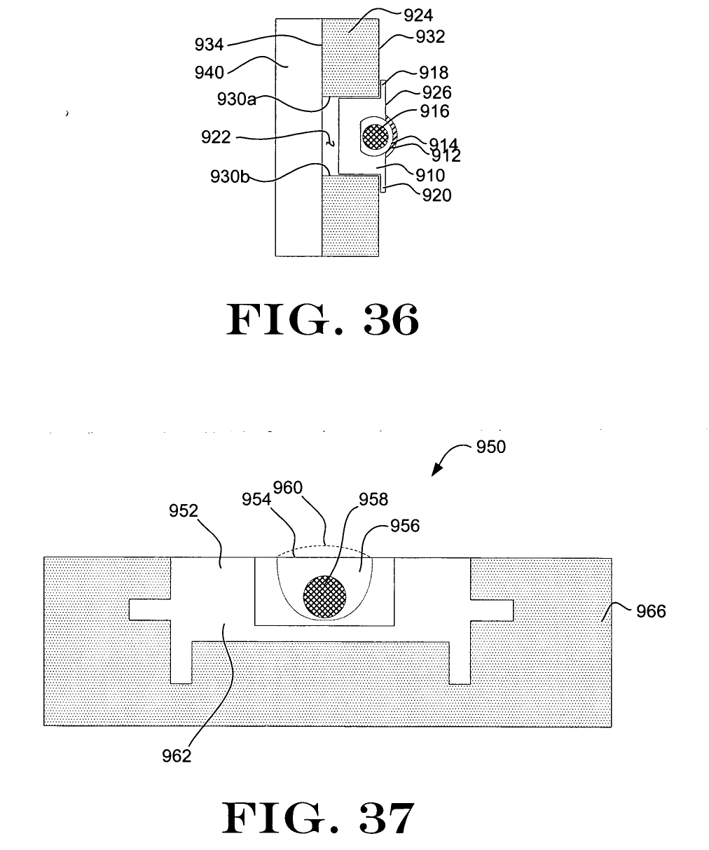

FIG. 36 is a cross-sectional side view of yet another illustrative lighting apparatus attached to a substrate. The illustrative lighting apparatus is shown generally at 908, and includes an elongated body 910. The elongated body 910 includes a cover portion 912, which together form an elongated cavity 914 for receiving an elongated light source 916. The elongated body 910 may be transparent or semi-transparent, or substantially non-transparent, depending on the application. In one illustrative embodiment, the cover 912 is transparent or semi-transparent, and the remainder of the body 910 is substantially non-transparent. The cover 912 may be shaped to form a lens, but this is not required. In another illustrative embodiment, the cover 912 is substantially non-transparent and the remainder of the body 910 is transparent or semi-transparent.

The elongated body 910 shown in FIG. 36 includes an upper extending leg 918 that extends upward from the remainder of the body 910, and a lower extending leg 920 that extends downward from the remainder of the body 910. The upper extending leg 918 and lower extending leg 920 may be relatively thin, and may extend outward from the remainder of the body 910 along a plane formed by the front face 926 of the remainder of the body 910, but this is not required.

In one embodiment, the main body 910 is inserted into an appropriately sized recess or hole 922 in a substrate 924. The upper extending leg 918 and lower extending leg 920 preferably extend out past the upper and lower edges 930a and 930b of the elongated recess or hole 922, and engage the front face 932 of the substrate 924 as shown. In some embodiments, the upper extending leg 918 and lower extending leg 920 are secured to the substrate by, for example, an adhesive, screws, or any other suitable securing method, as desired.

In some embodiments, the body does not extend to the backside 934 of the substrate 924. When so provided, the illustrative lighting apparatus may not disturb objects behind the substrate, such as studs 940 or any other members or objects behind the substrate 924. In other embodiments, the body 910 may extend to or beyond the backside 934 of the substrate 924, as desired.

FIG. 37 is a cross-sectional side view of an illustrative lighting apparatus for securing an elongated light source to a substrate. This embodiment may be particularly suitable for securing an elongated light source to a substrate that can be initially provided in a liquid or semi-liquid state, and then cured or hardened to a more solid state. The illustrative lighting apparatus is shown generally at 950, and includes an elongated member or body 952. The elongated member 952 includes a cover 954, which together form a cavity 956 for receiving an elongated light source 958.

The elongated member or body 952 may be transparent or semi-transparent, or substantially non-transparent, depending on the application. In one illustrative embodiment, the cover 954 is transparent or semi-transparent, and the remainder of the elongated member or body 952 is substantially non-transparent. The cover 954 may be flat, or shaped to form a lens such as a convex lens shown by dotted line 960. In another illustrative embodiment, the cover 954 is substantially non-transparent and the remainder of the elongated member or body 952 is transparent or semi-transparent.

It is contemplated that the cover 954 may be formed integrally with the remainder of the elongated member or body 952 (such as by, for example, extrusion, co-extrusion, molding, or any other suitable method). Alternatively, the cover 954 may be formed separately from the remainder of the elongated member or body 952. When formed separately from the remainder of the elongated member or body 952, the cover 954 may be later secured to the remainder of the elongated member or body 952 by, for example, a snapping mechanism, an adhesive, screws, or any other suitable securing method. In some embodiments, the cover 954 is secured to the remainder of the elongated member or body 952 after the elongated light source 958 is inserted into the cavity 956. In the illustrative embodiment, the cavity 956 is parabolic in shape to help direct (by reflection) the light produced by the elongated light source 958 toward the cover 954, but this is not required.

In some embodiments, the elongated member or body 952 may include a removable portion 962, which may include the cavity 956, the elongated light source 958 and the cover 954. The removable portion 962 may then be selectively removed from the remainder of the elongated member or body 952, as desired. This may be particularly useful when the remainder of the elongated member or body 952 is permanently secured to a substrate, as further described below.

The elongated member or body 952 may have one or more legs, such as legs 964a, 964b, 964c and 964d, which extend away from the remainder of the elongated member or body 952. In the embodiment shown, legs 964a, 964b, 964c and 964d may help secure the elongated member or body 952 to the substrate 966.

As noted above, this illustrative embodiment may be particularly suitable for securing an elongated light source to a substrate 966, and in particular, a substrate 966 that can initially be provided in a liquid or semi-liquid state, and then cured or hardened to a more solid state. For example, the substrate 966 may be poured in a liquid or semi-liquid state, and then the elongated member or body 952 may be inserted into the substrate 966 as shown. The liquid or semi-liquid substrate may flow around the legs 964a, 964b, 964c and 964d of the elongated member or body 952. When the substrate is cured or hardened to a more solid state, the elongated member or body 952 becomes secured to the substrate 966, and in some cases, permanently secured to the substrate 966.

In some embodiments, the substrate 966 may be, for example, concrete, asphalt, plastic, fiberglass, foam, or any other material that can be initially provided in a liquid or semi-liquid state, and then cured or hardened to a more solid state. The substrate may be part of, for example, a roadway, an airport runway, a wall, a floor, a stair, a ceiling, a running track, a boat, a car, a truck, a retaining wall, a swimming pool, a guard rail, or any other suitable surface or object, as desired.

In some embodiments, the elongated member or body 952 may be formed from a relatively rigid material, such as Vinyl, PVC, rubber, plastic, aluminum, or any other suitable material. When so provided, the removable portion 962 may be formed from the same or a different material than the elongated member or body 952.

For some applications, the elongated member or body 952 may be formed from a relatively flexible or elastic material. This may be useful when, for example, there is a difference in the coefficient of thermal expansion between the substrate 966 and the elongated member or body 952. Again, the removable portion 962 may be formed from the same or a different material such as a more rigid material, depending on the application.

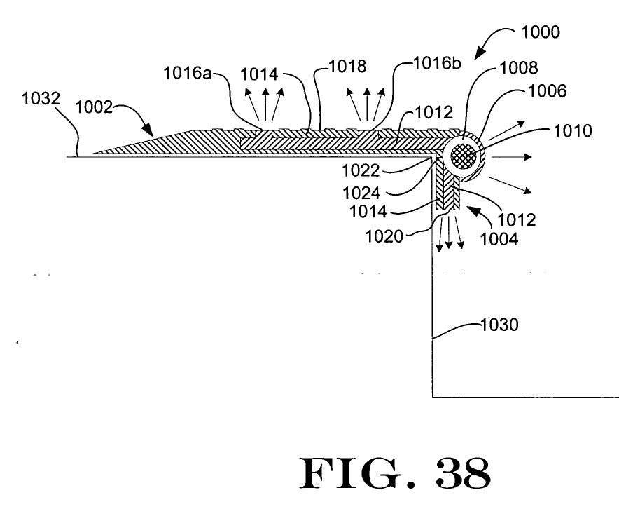

FIG. 38 is a cross-sectional side view of an illustrative lighting apparatus for use with a stair or other ledge. The illustrative lighting apparatus is generally shown at 1000, and includes an elongated member or body that has a horizontally extending portion 1002 and a vertically extending portion 1004. In some embodiments, either the horizontally extending portion 1002 or the vertically extending portion 1004 may be omitted. The illustrative elongated member includes a cover portion 1006, which together form a cavity 1008 for receiving an elongated light source 1010.

In the illustrative embodiment, the horizontally extending portion 1002 of the elongated member includes both a first material 1012 that is at least semi-transparent and a second material 1014 that is substantially non-transparent. The at least semi-transparent material 1012 is shown extending from the cavity 1008 that houses the elongated light source 1010 horizontally to one or more outer surfaces 1016a and 1016b of the body. The at least semi-transparent material 1012 thus at least partially defines the cavity 1008 and accepts light therefrom. The light is delivered down the at least semi-transparent material 1012 to the illuminate the one or more outer surfaces 1016a and 1016b. In the illustrative embodiment, the outer surface 1018 between the one or more outer surfaces 1016a and 1016b is substantially non-transparent, but this is not required. It is contemplated that the one or more outer surfaces 1016a and 1016b may be flat or shaped to form a lens, depending on the application. In addition, it is contemplated that the at least semi-transparent material 1012 may have a higher index of refraction than the substantially non-transparent material 1014 to promote greater total internal reflection of the light as it travels down the at least semi-transparent material 1012, much like an optical fiber.

The vertically extending portion 1004 of the elongated member may also include both a first material 1012 that is at least semi-transparent and a second material 1014 that is substantially non-transparent. The at least semi-transparent material 1012 is shown extending from the cavity 1008 that houses the elongated light source 1010 vertically down to an outer surface 1020 of the body. The at least semi-transparent material 1012 thus receives light from the cavity 1008, and delivers at least some of the light down to the outer surface 1020.

In some embodiments, the elongated member may include a slit 1024 that extends from the cavity 1008 to an outer surface of the body. The slit 1024 may be moved to an open position, by for example applying an external outward force, which may help aid in the insertion of the elongated light source 1010 into the cavity 1008 through the slit 1024.

In one illustrative embodiment, the at least semi-transparent material 1012 may be integrally formed with the substantially non-transparent material 1014. For example, the at least semi-transparent material 1012 may be co-extruded with the substantially non-transparent material 1014. Alternatively, the at least semi-transparent material 1012 may be separately formed from the substantially non-transparent material 1014, and subsequently mechanically secured together, as desired.

The illustrative lighting apparatus 1000 may be mounted to a stair or other ledge as shown. The cavity 1008 is shown positioned adjacent the ledge 1022 of the stair or ledge. However, it is contemplated that the cavity 1008 may be positioned anywhere along the elongated member, as desired, including adjacent the downward extending surface 1030 of the stair and/or adjacent the substantially horizontally extending surface 1032 of the stair.

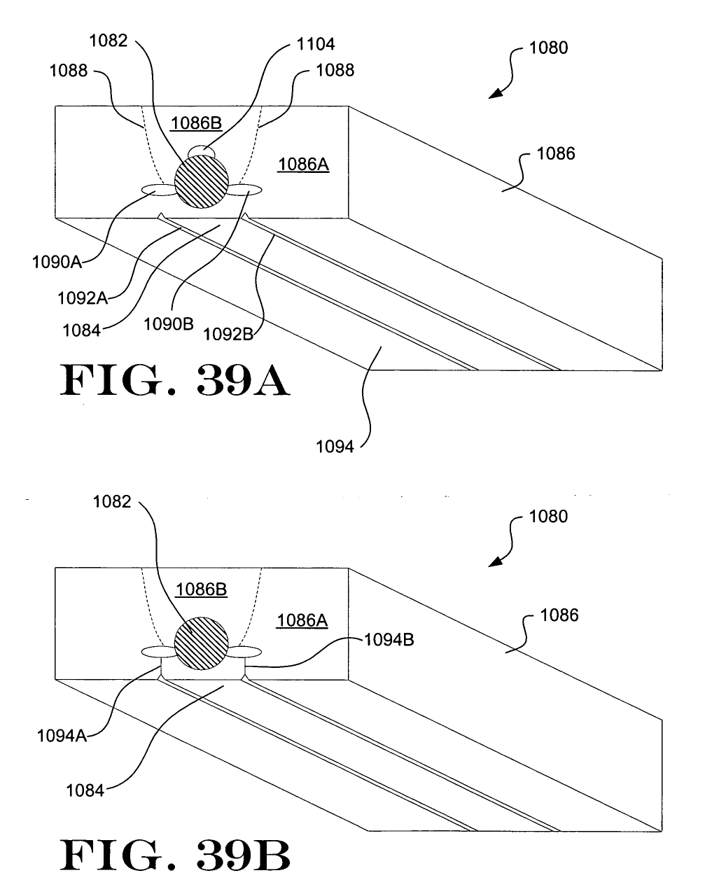

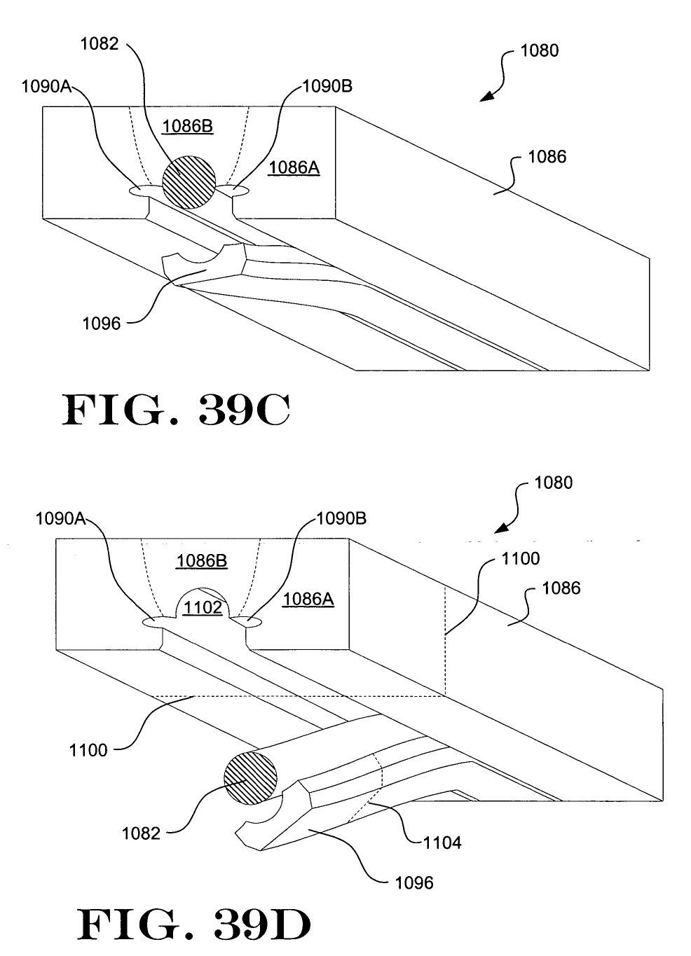

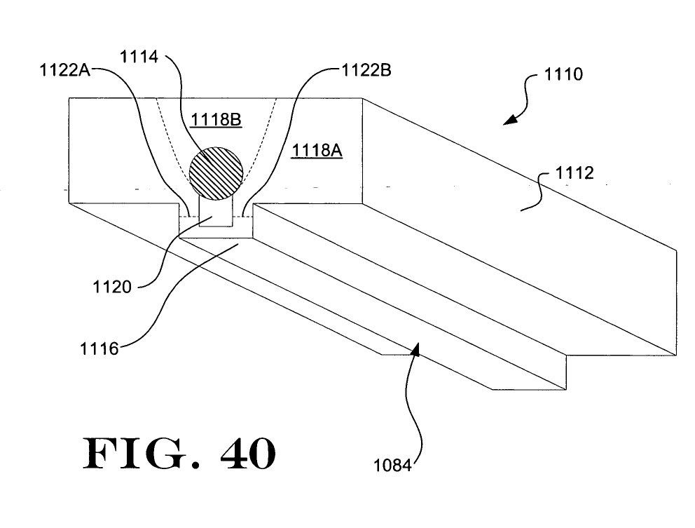

FIGS. 39A-39D are perspective views showing another illustrative lighting apparatus 1080 of the present invention. This illustrative lighting apparatus includes features to assist a user with the removal of at least a length of an elongated light source 1082 through a side 1084 of the lighting apparatus 1080. In the illustrative embodiment, the lighting apparatus 1080 is shown generally in schematic block form, but it is contemplated that the lighting apparatus 1080 may take on any useful shape and/or perform any useful function (e.g. a bumper function).

The illustrative lighting apparatus 1080 includes a housing 1086, with an elongated light source 1082 embedded or otherwise provided in the housing 1086. The elongated light source 1082 may extend along the length of the housing 1086. In some cases, the housing 1086 is extruded over the elongated light source 1082 to embed the elongated light source 1082 in the housing 1086, but this is not required.

The housing 1086 may, in some cases, be made from a transparent or semi-transparent material to allow light from the elongated light source 1082 to escape and be visible from the exterior of the housing 1086. In other cases, and as shown in FIG. 39A, the housing 1086 may include a non-transparent material 1086A and a transparent or semi-transparent material 1086B. In the illustrative embodiment, the boundary between the non-transparent material 1086A and transparent or semi-transparent material 1086B is shown by dotted lines 1088. When so provided, the transparent or semi-transparent material 1086B may extend to the elongated light source 1082 to allow at least some of the light from the elongated light source 1082 to escape to the exterior of the housing 1086.

It is contemplated that the elongated light source 1082 may be any type of elongated light source including, for example, an optical fiber such as a side emitting optical fiber, an electroluminescent wire (such as that commercially available from ELAM Electro-luminescent Industries Ltd., located in Jerusalem, Israel, under the Trademark LyTec™), an electroluminescent strip (such as the electroluminescent strip manufactured by E-Light Technologies Inc. of Stafford, Conn. under the trademark Flatlit®), or any other suitable elongated light source, as desired.

When the elongated light source 1082 is embedded in the housing 1086, as shown in FIG. 39A, it may be desirable to trim or cut the housing 1086 to a shorter length, and leave at least some of the elongated light source extending out past the housing 1086. For example, when the elongated light source 1082 is an electroluminescent wire, it may be necessary to provide one or more electrical connection to the electroluminescent wire for the electroluminescent wire to operate. Making these electrical connections may be made easier by first cutting the housing 1086 to length, and at the same time, leaving at least some of the electroluminescent wire extending out past the end of the housing 1086. In another example, it may be desirable to route the end of the elongated light source 1082 into or through a substrate (such as a boat or other substrate) while the housing 1086 continues along the surface of the substrate for a distance. In some cases, this may be facilitated by providing features that assist a user with the removal of at least a length of the elongated light source 1082 through a side wall 1084 of the lighting apparatus 1080.

In the illustrative embodiment shown in FIG. 39A, two relief holes 1090A and 1090B are provided. While two relief holes 1090A and 1090B are shown in FIG. 39A, it is contemplated that only one relief hole, or more than two relief holes may be provided, as desired. In the illustrative embodiment, the two relief holes 1090A and 1090B extend laterally away from the cavity that houses the elongated light source 1082. Although not required, the illustrative embodiment also includes a first score line 1092A along the lower surface 1094 of the housing 1086 in a parallel relation to the first relief hole 1090A, and a second score line 1092B along the lower surface 1094 of the housing 1086 in parallel relation to the second relief hole 1090B. The first score line 1092A is shown spaced a distance to the left of the edge of the elongated light source 1082, and the second score line 1092B is shown spaced a distance to the right of the edge of the elongated light source 1082. In the illustrative embodiment, the score lines 1092A and 1092B are spaced laterally away from the edges of the elongated light source so that a cutting instrument such as a blade that is slid along the score lines 1092A and 1092B will not engage and/or otherwise damage the elongated light source 1082.

To release the end of the elongated light source 1082, and in an illustrative method, a first cut 1094A may be made along the first score line 1092A to the first relief hole 1090A over a desired distance, and a second cut 1094B may be made along the second score line 1092B to the second relief hole 1090B over a similar distance, as shown best in FIG. 39B. Once the first cut 1094A and/or second cut 1094B are made, a released portion 1096 of the housing 1086 may be pulled away from the housing 1086, as best shown in FIG. 39C. The elongated light source 1082 may then also be pulled away from the housing 1086, as best shown in FIG. 39D. Thereafter, the remainder of the housing 1086 may be cut to length, such as along cut line 1100, leaving the end of the elongated light source 1082 extended out past the end of the housing 1086. In some cases, the released portion 1096 may also be cut to length, as shown by cut line 1104, if desired. While the use of score lines is shown in FIGS. 39A-39D, they are not required in all embodiments. Score lines 1092A and 1092B may, however, aid a user in more easily identifying and making the cuts 1094A and 1094B, when needed.

Referring to FIG. 39D, the cavity 1102 in the housing 1086 that receives the elongated light source 1082 is defined by a cavity wall. To make it easier to make the cuts 1094A and 1094B, it is contemplated that in some embodiments, the portion of the cavity wall that is, for example, below the cavity 1102 and adjacent the bottom side 1084 of the housing 1086, may be thinner than the cavity wall that is above the cavity 1102. In some cases, the thickness of the cavity wall that is below the cavity 1102 may be, for example, less than 10 millimeters (mm), less than 5 mm, less than 3 mm, less than 2 mm, less than 1 mm, or even paper thin, as desired. It has been found that cutting a thinner material, such as less than 10 millimeters, less than 5 mm, less than 3 mm, less than 2 mm, less than 1 mm, or even paper thin, is easier and more accurate than cutting a thicker material. It is also contemplated that the cavity wall that is below the cavity 1102 in FIG. 39A may be made from a different material than the cavity wall that is above and/or alongside the cavity 1102, but again, this is not required.

In some cases, and to reduce or eliminate the need to make cuts 1094A and 1094B, it is contemplated that the released portion 1096 (see FIG. 39C) of the housing 1086 may be secured only mildly to the adjacent part of the housing 1086. The released portion 1096 may then be removed, perhaps by peeling the released portion 1096 away from the remainder of the housing 1096. In one illustrative embodiment, the released portion 1096 may be secured mildly to the adjacent part of the housing 1086 by an adhesive. In another illustrative embodiment, the released portion 1096 may be made from a different material and co-extruded with the adjacent part of the housing 1986. The material selection and/or process parameters may be set such that the released portion 1096 is only mildly secured to the adjacent part of the housing 1086.

In some cases, it may be desirable to help reduce the stress on the elongated light source 1082, particularly when the elongated light source 1082 is embedded in the housing 1086 and/or when the housing 1086 is bent or otherwise deformed during use. To accomplish this, and in some embodiments, one or more relief holes, such as relief hole 1104 (shown in FIG. 39A) may be provided. The illustrative relief hole 1104 shown in FIG. 39A intersects the cavity 1102 that receives the elongated light source 1082, but this is not required in all embodiments.

FIG. 40 is a perspective view showing another illustrative light apparatus. This illustrative lighting apparatus also includes features to assist a user with the removal of at least a length of an elongated light source 1114 through a side 1115 of the lighting apparatus 1110. Again, in the illustrative embodiment, the lighting apparatus 1110 is shown generally in schematic block form, but it is contemplated that the lighting apparatus 1110 may take on any useful shape and/or perform any useful function (e.g. a bumper function).

The illustrative lighting apparatus 1110 includes a housing 1112, with an elongated light source 1114 embedded or otherwise provided in the housing 1112. The elongated light source 1114 may extend along the length of the housing 1112. In some cases, the housing 1112 is extruded over the elongated light source 1114, but this is not required.

The housing 1112 may, in some cases, be made from a transparent or semi-transparent material to allow light from the elongated light source 1114 to escape and be visible from the exterior of the housing 1112. In other cases, and as shown in FIG. 40, the housing 1112 may include a non-transparent material 1118A and a transparent or semi-transparent material 1118B. When so provided, the transparent or semi-transparent material 1118B may extend to the elongated light source 1114 to allow at least some of the light from the elongated light source 1114 to escape to the exterior of the housing 1112.

In the illustrative embodiment shown in FIG. 40, a relief hole 1120 extends laterally away from the cavity that houses the elongated light source 1114. To release the end of the elongated light source 1114, and in an illustrative method, a cut may be made along the cut lines 1122A and 1122B over a desired distance. Once the cut is made, a corresponding released portion 1116 of the housing 1112 may be pulled away from the housing 1112, similar to that shown in FIG. 39C above. The elongated light source 1114 may then also be pulled away from the housing 1112, similar to that shown in FIG. 39D. Thereafter, the remainder of the housing 1112 may be cut to length, similar to that shown in FIG. 39D, leaving the end of the elongated light source 1114 extending out past the end of the housing 1112. In some cases, the released portion 1116 may also be cut to length, if desired.

FIG. 41 is a cross-sectional side view of an illustrative lighting apparatus, generally show at 1200. The illustrative lighting apparatus 1200 includes a bumper member 1202 that is carried by a carrier 1204. In one illustrative embodiment, the bumper member 1202 is made from a flexible PVC, and the carrier is made from a rigid PVC, but this is not required. The carrier may be secured to a substrate, such as a boat, a wall, or any other substrate, as desired.

The illustrative bumper member 1202 has an elongated light source 1206 embedded therein along its length, as shown. In some embodiments, the bumper member is extruded over the elongated light source 1206, or molded over, but again, this is not required. In some cases, the elongated light source 1206 may be slid into a cavity in the bumper member 1202, in which case, the cavity may be slightly larger than the outside dimensions of the elongated light source 1206. In any event, to help facilitate the removal of at least a length of the elongated light source 1206 from the bumper member 1202, it is contemplated that the cavity wall that defines the cavity that houses the elongated light source 1206 may have a thinned side portion 1210. The thinned side portion 1210 may be thinner than a thicker side portion, such as thicker side portion 1212. The thicker side portion 1212 may be thicker to help protect the elongated light source and/or an attached substrate from abuse and/or damage during use. In the illustrative embodiment, the thicker side portion 1212 may function as a bumper. In some cases, the thinner side portion 1210 may have a thickness that is less than 10 mm, less than 5 mm, less than 3 mm, less than 2 mm, less than 1 mm, or even paper thin, as desired.

In the illustrative embodiment shown in FIG. 41, the thinner side portion 1210 may help facilitate the cutting of the thinner cavity wall to expose the elongated light source 1206. Once exposed, the elongated light source 1206 may be pulled away from the bumper member 1202 so that the remainder of the bumper member 1202 may be cut to length leaving at least a portion of the elongated light source 1206 extending out past the end of the bumper member 1202.

In some cases, the thinner side portion 1210 of the bumper member 1202 may be scored to help facilitate the cutting, tearing or ripping of the thinner cavity wall to expose the elongated light source 1206. Rather than a score line, some other marking may be used, such as ink or the like. Alternatively, or in addition, it is contemplated that the thinner side portion 1210 of the bumper member 1202 may be perforated or the like to help facilitate the cutting, tearing or ripping of the thinner cavity wall to expose the elongated light source 1206.

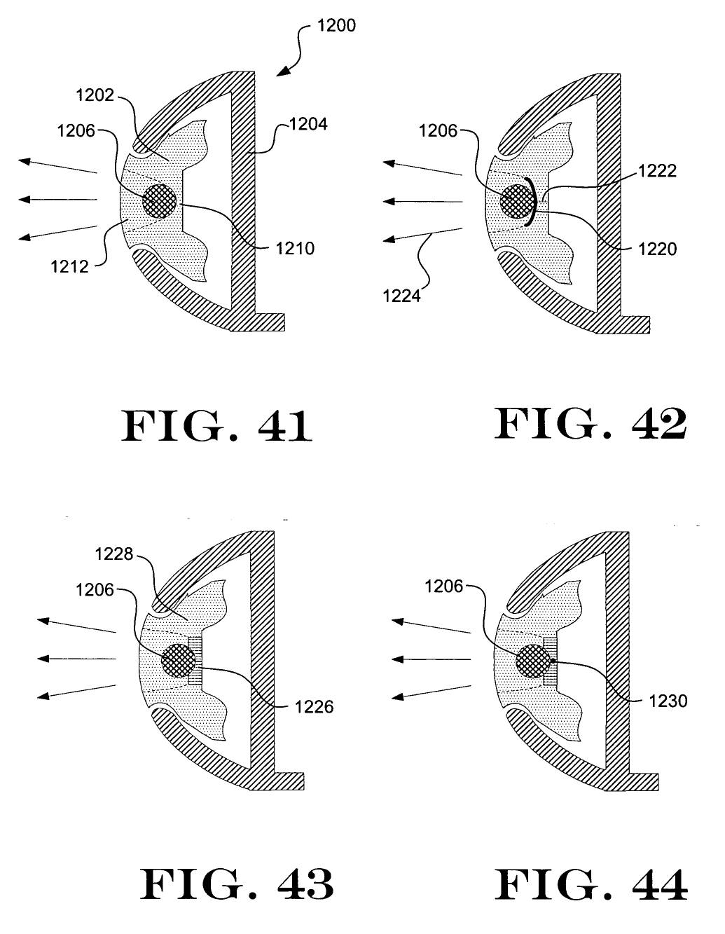

In some cases, and to help protect the elongated light source 1206 from damage during the cutting, tearing or ripping of the elongated light source cavity wall, it is contemplated that a protecting member 1220 may be provided along at least part of the cavity wall adjacent the elongated light source 1206, as best shown in FIG. 42. The protecting member 1220 may be embedded in the bumper member 1202, secured to the elongated light source 1206, or otherwise provided adjacent to the elongated light source 1206, as desired. The protecting member 1220 may be adapted to help protect the elongated light source 1206 from a cutting instrument such as a razor blade or the like, if the cavity wall is cut to expose the elongated light source 1206. An illustrative cut line is shown by dotted line 1222.

In some cases, a score line, perforation or other similar feature may be provided along the back side (e.g. at the cut line 1222 shown in FIG. 42) to facilitate the removal of at least a length of the elongated light source 1206, if desired. The protecting member 1220 may made from a durable plastic, metal or any other suitable material. In some cases, the protecting member 1220 may be at least partially reflective to help reflect light that is emitted by the elongated light source 1206, and out of the bumper member as show by arrows 1224.

In some cases, a portion of the cavity wall that defines the elongated light source cavity may be made from a different material than another part of the bumper member. One illustrative embodiment of this is shown in FIG. 43. In the illustrative embodiment shown in FIG. 43, a wall portion 1226 is made from a material that is easier to cut, tear or rip than other parts of the bumper member 1228. In some cases, the material forming the wall portion 1226 may be co-extruded with the material of other parts of the bumper member 1228, but this is not required. This may facilitate the cutting, tearing or ripping of the wall portion 1226 so that the at least a length of the elongated light source 1206 may be removed from the remainder of the bumper member 1228. Like above, and in some cases, a score line, perforation or other similar feature may be provided along the back side of the wall portion 1226 to further facilitate the removal of at least a length of the elongated light source 1206, if desired. Also, the wall portion 1226 may be a thinner wall portion, but this is not required.

Like above, and in some cases, it is contemplated that the material forming the wall portion 1226 may be secured only mildly to the adjacent part of the bumper member 1228. The wall portion 1226 may then be removed, perhaps by peeling the wall portion 1226 away from the remainder of the bumper member 1228. In one illustrative embodiment, the wall portion 1226 may be secured mildly to the adjacent part of the bumper member 1228 by an adhesive. In another illustrative embodiment, the wall portion 1226 may be made from a different material and co-extruded with the adjacent part of the bumper member 1228. The material selection and/or process parameters may be set such that the wall portion 1226 is only mildly secured to the adjacent part of the bumper member 1228.

In some cases, and as best shown in FIG. 44, an elongated tear assist member 1230 may be provided, and may extend lengthwise along at least part of the thinner portion of the elongated light source cavity wall. The elongated tear assist member 1230 may be, for example, a wire or the like that extends adjacent to the elongated light source 1206. The tear assist member 1230 may help cut, tear or rip the thinner portion of the elongated light source cavity wall when the tear assist member 1230 is pulled toward the thinner portion of the elongated light source cavity wall. In some cases, a score line, perforation or other similar feature may be provided along the thinner portion of the elongated light source cavity wall to further facilitate the cutting, tearing or ripping of the thinner portion of the elongated light source cavity wall, and thus the removal of at least a length of the elongated light source 1206 from the remainder of the bumper member, if desired.

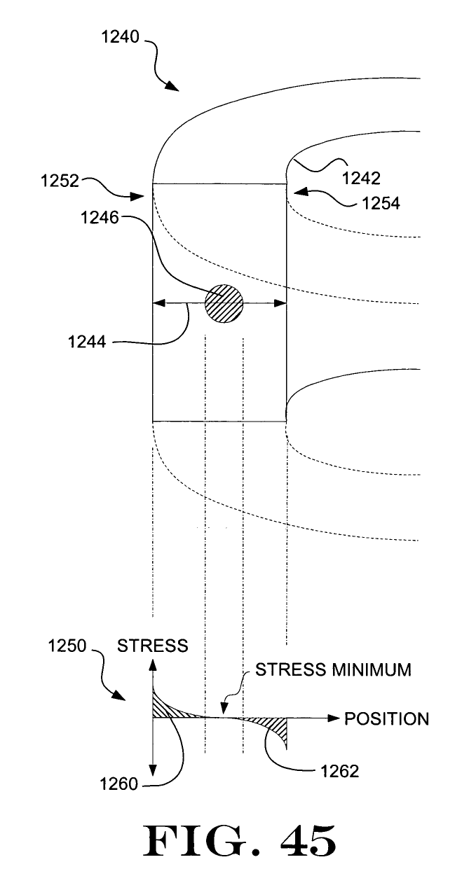

FIG. 45 is a partial perspective cut away view of an illustrative lighting apparatus 1240 that is bent around a corner 1242 and has a resulting stress profile across its width 1244, with an elongated light source 1246 positioned at or near the minimum of the stress profile. An illustrative stress profile is shown generally at 1250, which shows the stress in the bent lighting apparatus 1240 in the width dimension 1244. The material along the outer side 1252 of the lighting apparatus 1240 may be stretched because of the bend as illustrated by the positive stress curve 1260, and the inner side 1254 may be compressed as illustrated by the negative stress curve 1262. The stress profile shown at 1250 is only schematically shown. The particular stress profile may be different depending on a number of factors including, for example, the material or materials involved, the shape of the lighting apparatus 1240, the particular bend involved, as well as other factors. Because it may be desirable to reduce the stress on the elongated light source 1246, it is contemplated that the elongated light source 1246 may be positioned at or near the minimum of the stress profile. This may be particularly true when the elongated light source 1246 is embedded in the lighting apparatus 1240. In some cases, at least part of the elongated light source 1246 resides at the minimum in the stress profile of the lighting apparatus when the lighting apparatus is bent or otherwise deformed during use.

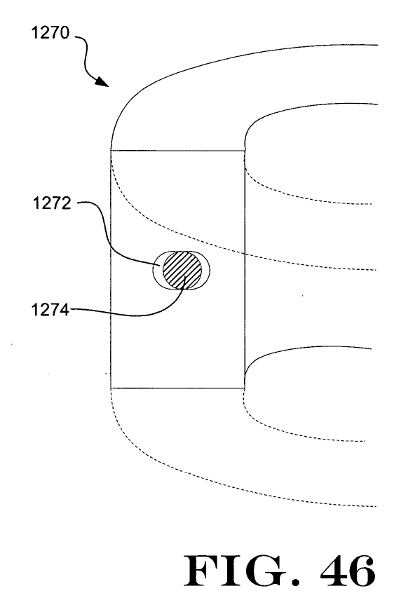

FIG. 46 is a partial perspective cut away view of an illustrative lighting apparatus that is bent around a corner. In this illustrative embodiment, the lighting apparatus 1270 includes a cavity 1272 that is larger in the direction of the bend than the outer dimension of the elongated light source 1274. This may help reduce the stress on the elongated light source 1274 when the illustrative lighting apparatus is bent around a corner. In some embodiments, the illustrative lighting apparatus 1270 may be extruded over the elongated light source 1274, leaving a cavity 1272 that is larger in the direction of the bend than the outer dimension of the elongated light source 1274. In other cases, an enlarged cavity may be provided in the lighting apparatus 1270, and the elongated light source may be slid into the cavity, as desired. While the elongated light source shown is shown as being substantially round in many of the above Figures, it is contemplated that the elongated light source may be any suitable type of elongated light source, and/or any suitable shape and/or size, as desired.

It is contemplated that the features and concepts described with reference to FIGS. 39A-46 may also be applied to the embodiments shown and described with respect to FIGS. 1-38, as desired.

Having thus described the preferred embodiments of the present invention, those of skill in the art will readily appreciate that the teachings found herein may be applied to yet other embodiments within the scope of the claims hereto attached.

What is claimed is:

1. A method for cutting an elongated housing to a shorter length, wherein the elongated housing has an elongated light source embedded in a cavity along a length of the elongated housing, the cavity having a cavity wall, the method comprising:
cutting, ripping, tearing or peeling away at least part of the cavity wall to expose the elongated light source;
removing at least a length of the elongated light source from the cavity through the cut, rip, tear or peeled away portion of the cavity wall; and
cutting the elongated housing, without cutting the elongated light source, thereby allowing at least some of the elongated light source to extend out past the cut end of the elongated housing.

2. The method of claim 1, wherein the part of the cavity wall that is cut, ripped, torn or peeled away is thinner than another portion of the cavity wall.

3. The method of claim 2, wherein the part of the cavity wall that is cut, ripped, tore or peeled away is less than 10 mm thick.

4. The method of claim 3, wherein the part of the cavity wall that is cut, ripped, tore or peeled away is less than 3 mm thick.

5. The method of claim 4, wherein the part of the cavity wall that is cut, ripped, tore or peeled away is less than 1 mm thick.

6. An elongated housing adapted to receive an elongate light source and further adapted to be bent around a corner, comprising:
an elongated member having a cavity extending lengthwise therethrough for receiving an elongated light source, the elongated member having a stress profile when the elongated housing is bend around a corner; and
the cavity being located such that at least part of the cavity is at a minimum of the stress profile.

7. The elongated housing of claim 6 wherein the elongated light source is embedded in the elongated member.

8. The elongated housing of claim 7 wherein the elongated member is extruded over the elongated light source.

9. The elongated housing of claim 8 wherein the cavity has a dimension that is larger than the same dimension of the elongated light source in at least one direction.

10. An elongated housing adapted to receive an elongate light source, comprising:
an elongated member having a cavity extending lengthwise therethrough for receiving an elongated light source; and
the cavity defined by a cavity wall, wherein the cavity wall has a thinner portion with a thickness that is less than 3 mm, and a thicker portion that has a thickness that is greater than 3 mm.

11. The elongated housing of claim 10, further comprising a perforation extending lengthwise along at least part of the thinner portion of the cavity wall.

12. The elongated housing of claim 10, further comprising a score line extending lengthwise along at least part of the thinner portion of the cavity wall.

13. The elongated housing of claim 10, further comprising a light source protecting member extending lengthwise along at least part of the thinner portion of the cavity wall adjacent the elongated light source.

14. The elongated housing of claim 13, further comprising a score line extending lengthwise along at least part of an outer facing surface of the thinner portion of the cavity wall.

15. The elongated housing of claim 10, further comprising an elongated tear assist member extending lengthwise along at least part of the thinner portion of the cavity wall.

16. The elongated housing of claim 10, wherein at least part of the thicker portion of the cavity wall is transparent or semi-transparent.

17. The elongated housing of claim 16, wherein at least part of the thicker portion of the cavity wall is adapted to function as a bumper.

18. The elongated housing of claim 17, wherein at least part of the thicker portion of the cavity wall is adapted to function as a bumper for a boat.

19. The elongated housing of claim 16, further comprising a carrier member for carrying the elongated housing.

20. The elongated housing of claim 19, wherein the carrier is adapted to be fixed to a substrate.

21. The elongated housing of claim 16 further comprising an elongated light source situated in at least part of the cavity.

22. The elongated housing of claim 21, wherein the elongated light source is an electroluminescent light source.

23. The elongated housing of claim 21, wherein the elongated housing is extruded over the elongated light source.

24. An elongated housing adapted to receive an elongate light source, comprising:
an elongated member extruded over an elongated light source, the elongated light source positioned in an elongated cavity; and
the cavity have a laterally extending out portion that extends laterally from the elongated light source in at least one direction.

25. The elongated housing of claim 24 further comprising a score line or other marking along an outer surface of the elongated housing, the score line or other marking aligned generally with at least part of the laterally extending out portion of the cavity.
